(19) United States
(12) Patent Application Publication
(10) Pub. No.: US 2025/0042209 A1
(43) Pub. Date: Feb. 6, 2025

(54) AMPHIBIOUS VEHICLE

(71) Applicant: Ontario Drive & Gear Limited, New Hamburg (CA)

(72) Inventors: Brian William DICK, Thief River Falls, MN (US); Nikolas Couturier MCCLUSKEY, Sherbrooke (CA); Jason Alexander BONIN, Milton (CA); Claude Pierre BEAUDOIN, Cookshire-Eaton (CA); Shawn Anthony MONAHAN, New Hamburg (CA); Alexander Thomas OPRATKO, Stratford (CA); Dayne Bradley EFTA, Newfolden, MN (US); Daniel Wayne DOTZERT, Petersburg (CA); Jeremy Damon BAUMAN, Plattsville (CA); Ryan Matthew SOLTAU, Thief River Falls, MN (US); Justin Michael KUNZ, Thief River Falls, MN (US); Michael Kevin SCHLEY, Holt, MN (US); Dustin Donald KELLER, Lindstrom, MN (US); Paul Calvin ECKSTEIN, St. Hilaire, MN (US); Keith Louis HEIBEIN, Cambridge (CA); Brett STOLTZ, West Chester, OH (US); Carlos Augusto ROJAS NINO, Waite Park, MN (US); Michael Aaron BRATENG, Litchfield, MN (US)

(73) Assignee: Ontario Drive & Gear Limited, New Hamburg, ON (CA)

(21) Appl. No.: 18/605,151

(22) Filed: Mar. 14, 2024

Related U.S. Application Data
(60) Provisional application No. 63/452,062, filed on Mar. 14, 2023.
(60) Provisional application No. 63/537,533, filed on Sep. 10, 2023.

(51) Int. Cl. B60F 3/00; B60K 17/04; B60T 7/04; B60T 7/08; B62D 5/04; B62D 33/027; F16H 37/02

(52) U.S. Cl. CPC B60F 3/0007; B60F 3/0046; B60K 17/04; B60T 7/04; B60T 7/08; B62D 5/0421; B62D 33/027; F16H 37/022

(57) ABSTRACT

An amphibious vehicle that can be operated in a variety of conditions and terrain, including on land and in water, includes a high visibility cab portion, a chassis, and prime mover. The amphibious vehicle has two rows of forward-facing seats situated inside the cab portion, allowing both the operator and passengers to look outside via the high visibility cab portion. A CVT and steering-wheel interface for steering is utilized to provide the operator with an intuitive driving experience.

### CROSS-REFERENCE TO RELATED APPLICATIONS

This application claims the benefit of and priority to U.S. Application No. 63/452,062, having a filing date of Mar. 14, 2023, and titled Amphibious Vehicle, the entire contents of which are hereby incorporated by reference. This application also claims the benefit of and priority to U.S. Application No. 63/537,533, having a filing date of Sep. 10, 2023, and titled Amphibious Vehicle and Steering System, the entire contents of which are hereby incorporated by reference.

### BACKGROUND

Various styles of amphibious vehicles have been utilized to operate with varying degrees of success on land, water, and in difficult landscapes including snow, mud, sand, and even over rocks and bumpy terrain. There remains a need, however, for amphibious vehicles having improved performance and reliability, as well as intuitive operation and good visibility.

All US patents and applications and all other published documents mentioned anywhere in this application are incorporated herein by reference in their entirety.

### SUMMARY

In some embodiments, an amphibious vehicle includes a chassis, front entry access, side entry access, and splash shield. The side entry access has a side lower door and the side lower door has a closed configuration and an open configuration. The splash shield extends around at least a portion of the vehicle. A portion of the splash shield is attached to the side lower door and has a first surface and a second surface. When the side lower door is in the closed configuration the first surface faces upwardly and when the side lower door is in the open configuration the first surface faces downwardly.

In some embodiments, the amphibious vehicle includes a continuously variable transmission.

In some embodiments, the amphibious vehicle includes a range transmission, and the range transmission has at least one forward speed and one reverse speed.

In some embodiments, the range transmission has at least one set of epicyclic gears.

In some embodiments, the amphibious vehicle includes a steering wheel.

In some embodiments, the amphibious vehicle includes a steering motor, and the steering motor is coupled to the range transmission such that rotation of the steering wheel provides a signal to command the steering motor.

In some embodiments, the amphibious vehicle includes front seats and rear seats. At least one of the front seats and at least one of the rear seats are forward facing.

In some embodiments, an amphibious vehicle includes a chassis, a front entry access, a prime mover having a crankshaft axis, a range transmission, and a CVT. The CVT has a drive clutch and a driven clutch, and the drive clutch has an axis about which it rotates. The axis of the drive clutch is offset from the crankshaft axis.

In some embodiments, the crankshaft axis extends transversely relative to the amphibious vehicle.

In some embodiments, the amphibious vehicle includes an electric steering motor.

In some embodiments, the electric steering motor is coupled to the range transmission.

In some embodiments, the amphibious vehicle includes a box portion, and the box portion has a tailgate. The tailgate opens about one or more tailgate hinges.

In some embodiments, an amphibious vehicle includes a chassis, a cab portion affixed to the chassis, at least four tires, a prime mover, a CVT, a range transmission, a steering motor, a steering wheel, and a tire inflation system. The cab portion has a front entry access and a side entry access. The tires each have a diameter of at least 60 inches. The prime mover is a diesel engine, and the diesel engine has a crank pulley coupled thereto. The CVT includes a drive clutch and a drive clutch. The drive clutch is coaxial with clutch pulley. The crank pulley and the clutch pulley are rotationally coupled to one another via a drive belt. The drive clutch and driven clutch are coupled via a CVT belt. The range transmission has a power input shaft and a steering input. The driven clutch is rotationally coupled to the power input shaft. The steering motor rotationally coupled to the steering input. The tire inflation system includes an air pump, an electric motor, and a plurality of air valves. The tire inflation system is coupled to four tires.

In some embodiments, the amphibious vehicle includes a first alternator and a second alternator.

In some embodiments, the amphibious vehicle includes a box portion, and the box portion includes a storage locker.

In some embodiments, the amphibious vehicle includes a radiator and a radiator cooling fan. The radiator cooling fan is rotationally coupled to an electric motor.

In some embodiments, the amphibious vehicle includes a box portion and a box illumination light. The box illumination light selectively provides illumination for the box portion.

In some embodiments, the amphibious vehicle includes a brake system, and the brake system includes a brake pedal, a hand brake, and a brake disc. Both the brake pedal and the hand brake are configured to act on the brake disc.

In some embodiments, the amphibious vehicle includes a drive belt tensioning assembly, and the drive belt tensioning assembly includes a CVT tensioning support member and a main support member. The CVT tensioning support member is pivotable relative to the main support member.

In some embodiments, the amphibious vehicle has a crank pulley, and the crank pulley has a larger diameter than the clutch pulley.

In some embodiments, the tires have a diameter between 60 and 80 inches. In some embodiments, the tires have a diameter between 65 and 75 inches.

### BRIEF DESCRIPTION OF THE DRAWINGS

FIG. 1 is an isometric view of an amphibious vehicle according some embodiments.

FIG. 2. is a side view of the left side of the amphibious vehicle of FIG. 1.

FIG. 3 is a side view of the right side of the amphibious vehicle of FIG. 1.

FIG. 4 is a front view of the amphibious vehicle of FIG. 1.

FIG. 5 is a rear view of the amphibious vehicle of FIG. 1.

FIG. 6 is a top view of the amphibious vehicle of FIG. 1.

FIG. 7 is a bottom view of the amphibious vehicle of FIG. 1.

FIG. 8 is an isometric view of an amphibious vehicle of FIG. 1 with various doors and hatches open.

FIG. 9 is a side view of the left side of the amphibious vehicle of FIG. 8.

FIG. 10 is a front view of the amphibious vehicle of FIG. 8.

FIG. 11 is a rear view of the amphibious vehicle of FIG. 8.

FIG. 12 is a top view of the amphibious vehicle of FIG. 8

FIG. 13 is a bottom view of the amphibious vehicle of FIG. 8

FIG. 14 is an isometric view of frame members, chassis, and box portion of the amphibious vehicle of FIG. 1.

FIG. 15 is a side view of the left side of frame members, chassis, and box portion of FIG. 14.

FIG. 16 is a side view of the right side of frame members, chassis, and box portion of FIG. 14.

FIG. 17 is a front view of frame members, chassis, and box portion of FIG. 14.

FIG. 18 is a rear view of frame members, chassis, and box portion of FIG. 14.

FIG. 19 is a top view of frame members, chassis, and box portion of FIG. 14.

FIG. 20 is an isometric view of frame members and chassis of the amphibious vehicle of FIG. 1.

FIG. 21 is a side view of the left side of the frame members and chassis of FIG. 20.

FIG. 22 is a rear view of the frame members and chassis of FIG. 20.

FIG. 23 is a top view of the frame members and chassis of FIG. 20.

FIG. 24 is an isometric view showing panels and frame members of the cab portion of the amphibious vehicle of FIG. 1.

FIG. 25 is an isometric view of the chassis and mechanical components of the amphibious vehicle of FIG. 1.

FIG. 26 is a detailed view of the chassis and mechanical components of FIG. 25.

FIG. 27 is a top view of the chassis and mechanical components of FIG. 25.

FIG. 28 is an isometric view of the driveline and mechanical components of the amphibious vehicle of FIG. 1.

FIG. 29 is a side view of the left side of the driveline and mechanical components of FIG. 28.

FIG. 30 is a side view of the right side of the driveline and mechanical components of FIG. 28.

FIG. 31 is a front view of the driveline and mechanical components of FIG. 28.

FIG. 32 is a rear view of the driveline and mechanical components of FIG. 28.

FIG. 33 is a top view of the driveline and mechanical components of FIG. 28.

FIG. 34 is a bottom view of the driveline and mechanical components of FIG. 28.

FIG. 35 is an isometric view of the driveline of the amphibious vehicle of FIG. 1.

FIG. 36 is a detailed top view of the left side of the driveline of the amphibious vehicle of FIG. 1.

FIG. 37 is a cross-sectional view of the section identified in FIG. 36.

FIG. 38 is a cross-sectional view of the section identified in FIG. 36.

FIG. 39 is a cross-sectional view of the section identified in FIG. 36.

FIG. 40 is a cross-sectional view of the section identified in FIG. 36.

FIG. 41 is an isometric view of the prime mover, range transmission, and brake assembly of the amphibious vehicle of FIG. 1.

FIG. 42 is a side view of the right side of the prime mover, range transmission, and brake assembly of FIG. 41.

FIG. 43 is a top view of the prime mover, range transmission, and brake assembly of FIG. 41.

FIG. 44 is an isometric view of the prime mover, range transmission, CVT, and range selector of the amphibious vehicle of FIG. 1.

FIG. 45 is an isometric view of the prime mover, range transmission, and CVT of the amphibious vehicle of FIG. 1.

FIG. 46 is a side elevational view of the left side of the prime mover and CVT supports of the amphibious vehicle of FIG. 1.

FIG. 47 is a side elevational view of the right side of the prime mover, CVT, and CVT supports of the amphibious vehicle of FIG. 1.

FIG. 48 is a front elevational view of the prime mover, CVT, and CVT supports of the amphibious vehicle of FIG. 1.

FIG. 49 is an isometric view of the tire inflation system and driveline of the amphibious vehicle of FIG. 1.

FIG. 50 is an isometric view of the tire inflation system of the amphibious vehicle of FIG. 1.

FIG. 51 is a side view of the left side of the tire inflation system of FIG. 50.

FIG. 52 is a top view of the tire inflation system, chassis, and tires of the amphibious vehicle of FIG. 1.

FIG. 53 is a cross-sectional view of the section identified in FIG. 52.

FIG. 54 is a detailed cross-sectional view of the cross-sectional view in FIG. 53.

FIG. 55 is an isometric view of the chassis, mechanical components, and box portion of the amphibious vehicle of FIG. 1.

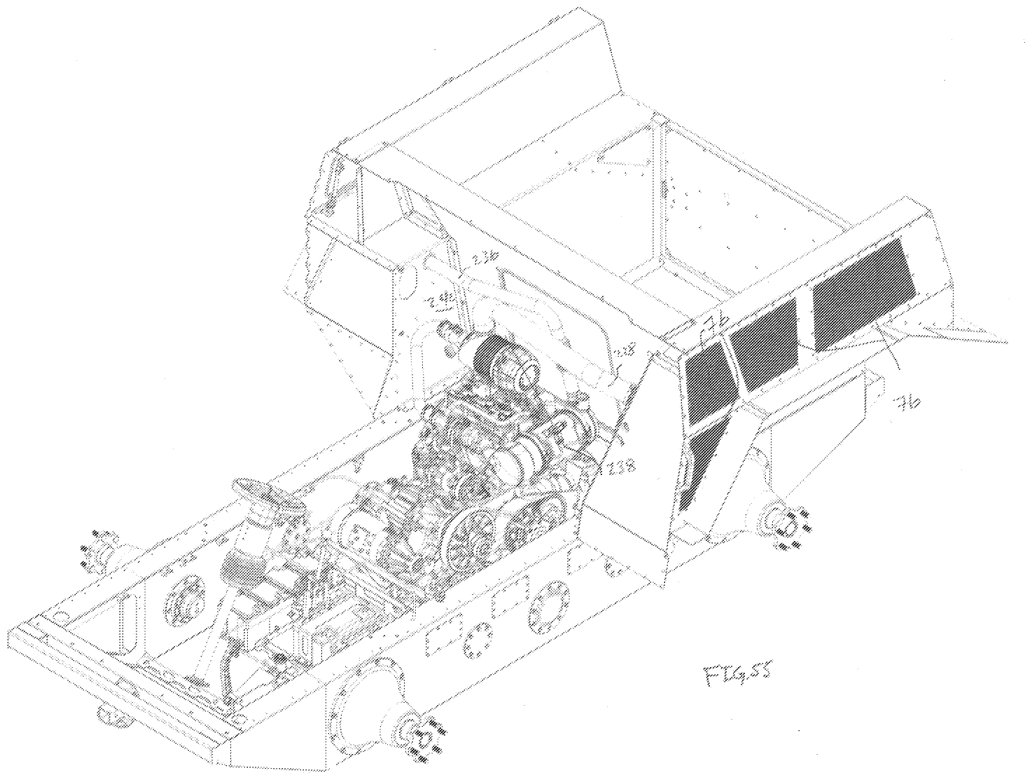

FIG. 56 is an isometric view of the chassis, mechanical components, and box portion of the amphibious vehicle of FIG. 1.

FIG. 57 is a partial cutaway view of the cab portion and chassis of the amphibious vehicle of FIG. 1.

FIG. 58 is a partial cutaway view of the cab portion and chassis of the amphibious vehicle of FIG. 1.

FIG. 59 is a partial cutaway view of the cab portion and chassis of the amphibious vehicle of FIG. 1.

FIG. 60 is a forward-looking, elevational, partial cutaway view of the cab portion and chassis of the amphibious vehicle of FIG. 1.

FIG. 61 is a forward-looking, quartering, partial cutaway view of the cab portion and chassis of the amphibious vehicle of FIG. 1.

FIG. 62 is a partial cutaway view of the cab portion and chassis of the amphibious vehicle of FIG. 1.

FIG. 63 is a partial cutaway view of the cab portion and chassis of the amphibious vehicle of FIG. 1.

FIG. 64 is a partial cutaway down and rearward looking view of the cab portion and chassis of the amphibious vehicle of FIG. 1.

FIG. 65 is a partial cutaway view of the cab portion and chassis of the amphibious vehicle of FIG. 1.

FIG. 66 is a partial cutaway downward looking view of the cab portion of the amphibious vehicle of FIG. 1.

FIG. 67 is a side cutaway view of the cab portion of the amphibious vehicle of FIG. 1.

FIG. 68 is a side cutaway view of the cab portion of the amphibious vehicle of FIG. 1.

FIG. 69 is an isometric view of the prime mover, range transmission, and CVT of the amphibious vehicle of FIG. 1 according to another embodiment.

FIG. 70 is a side elevational view of the left side of the prime mover and CVT supports of the amphibious vehicle of FIG. 1 according to another embodiment.

FIG. 71 is a side elevational view of the right side of the prime mover, CVT, and CVT supports of the amphibious vehicle of FIG. 1 according to another embodiment.

FIG. 72 is a front elevational view of the prime mover, CVT, and CVT supports of the amphibious vehicle of FIG. 1 according to another embodiment.

FIG. 73 is a flow diagram for a steering controller of the amphibious vehicle of FIG. 1.

### DETAILED DESCRIPTION

While the invention(s) may be embodied in many different forms, there are described in detail herein specific embodiments of the invention(s). This description is an exemplification of the principles of the invention(s) and is not intended to limit the invention(s) to the particular embodiments illustrated.

For the purposes of this disclosure, like reference numerals in the figures shall refer to like features unless otherwise indicated.

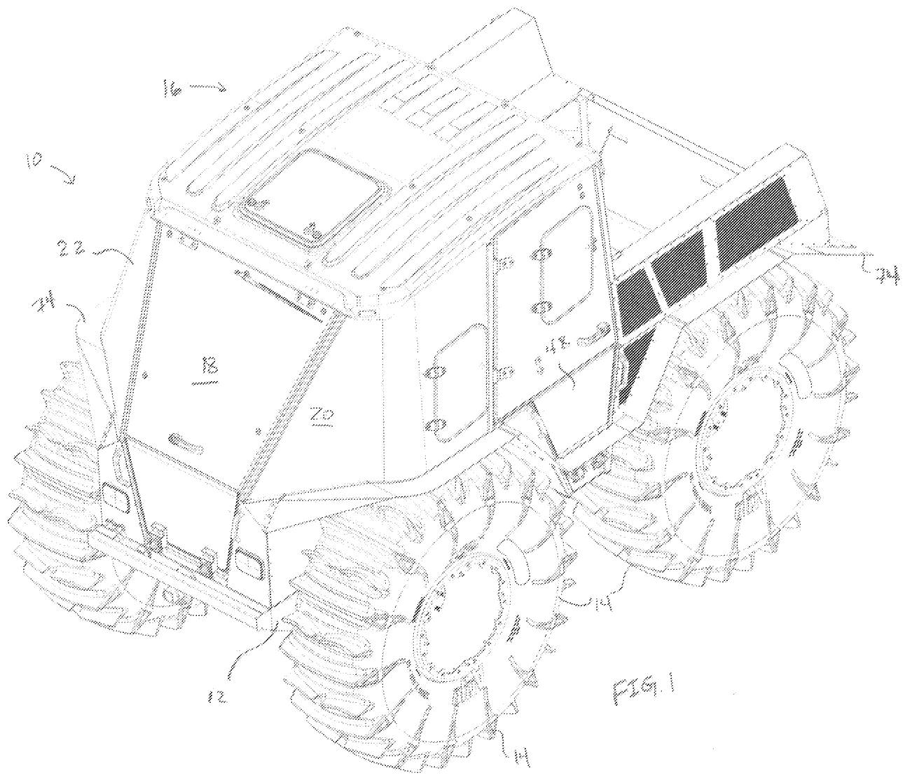

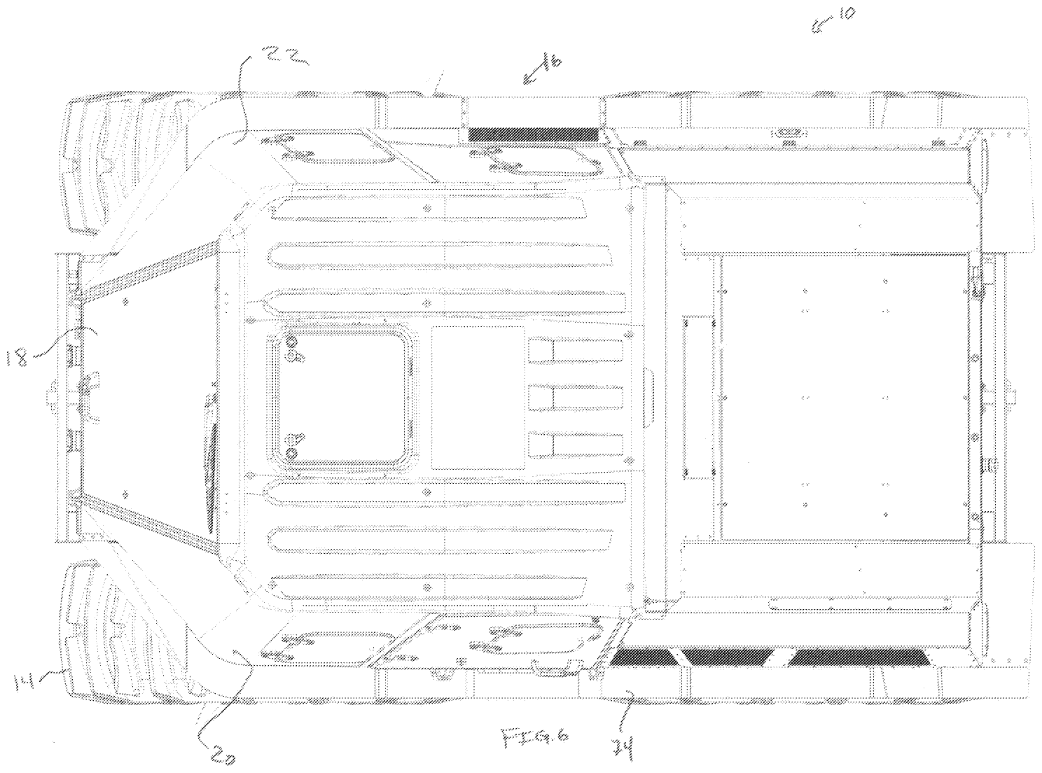

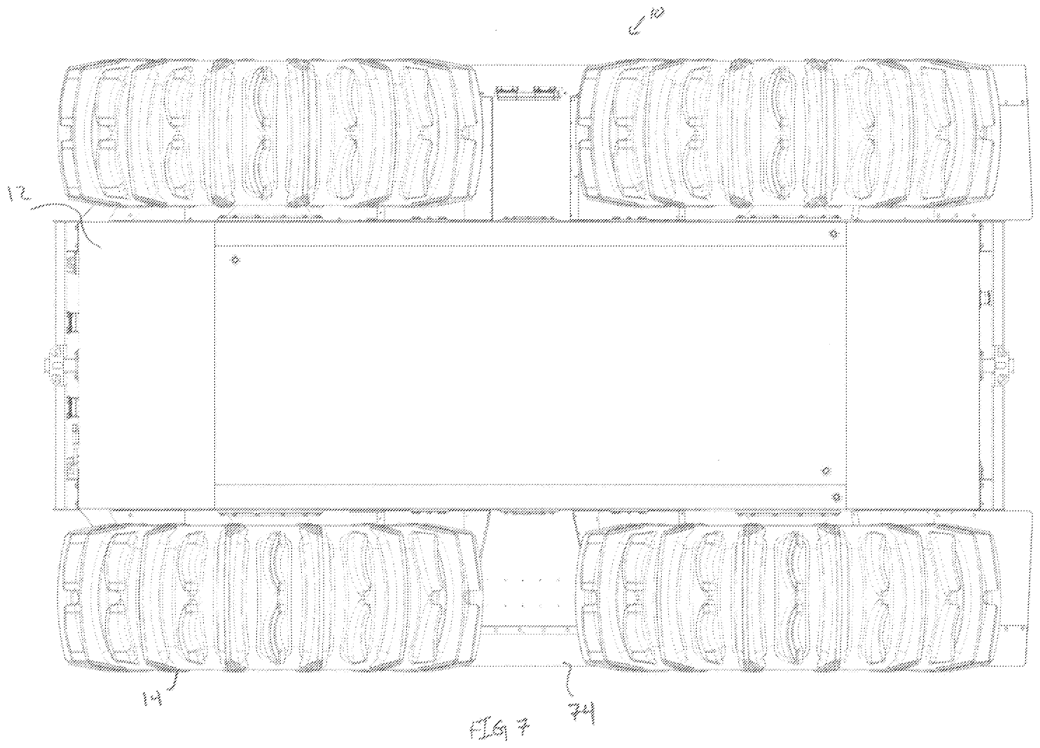

In some embodiments, for example as shown in FIGS. 1-7, a vehicle 10 includes a chassis 12, and a plurality of ground engaging members 14. In some embodiments, the ground engaging members 14 are low pressure inflatable tires, for example having a maximum pressure of five psi (pounds per square inch) and, in some embodiments, having a maximum pressure of three psi. As further shown, in some embodiments, the vehicle 10 can include tracks (not shown), for example in lieu of the tires 14.

Referring to FIGS. 1-6, the vehicle 10 further includes a cab portion 16. In at least some embodiments, the cab portion 16 is affixed to the chassis 12, for example with a plurality of fasteners (such as bolts). The cab portion 16 includes operator controls and one or more seats. The cab portion 16 further includes numerous transparent portions (e.g., windows) permitting the operator (as well as passengers) to see out of the vehicle 10 with few obstructions. In some embodiments, the cab portion 16 includes a front windshield 18, side windows 20, 22 which wrap around from the front windshield 18 to respective sides of the vehicle 10. In this way, the operator has an excellent field of unobstructed views out of the front and sides of the vehicle 10.

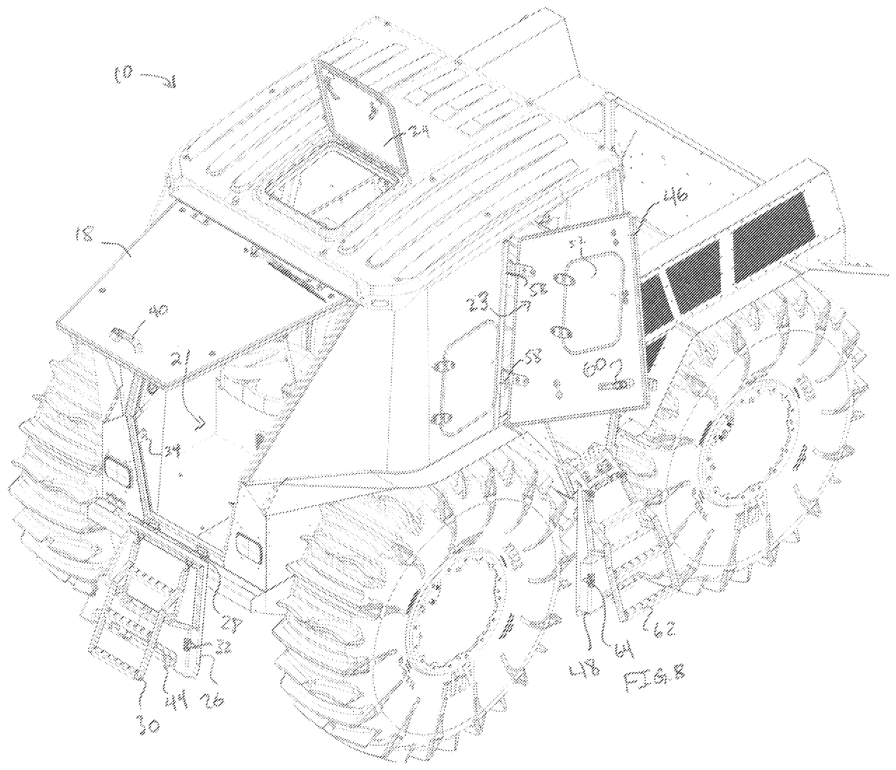

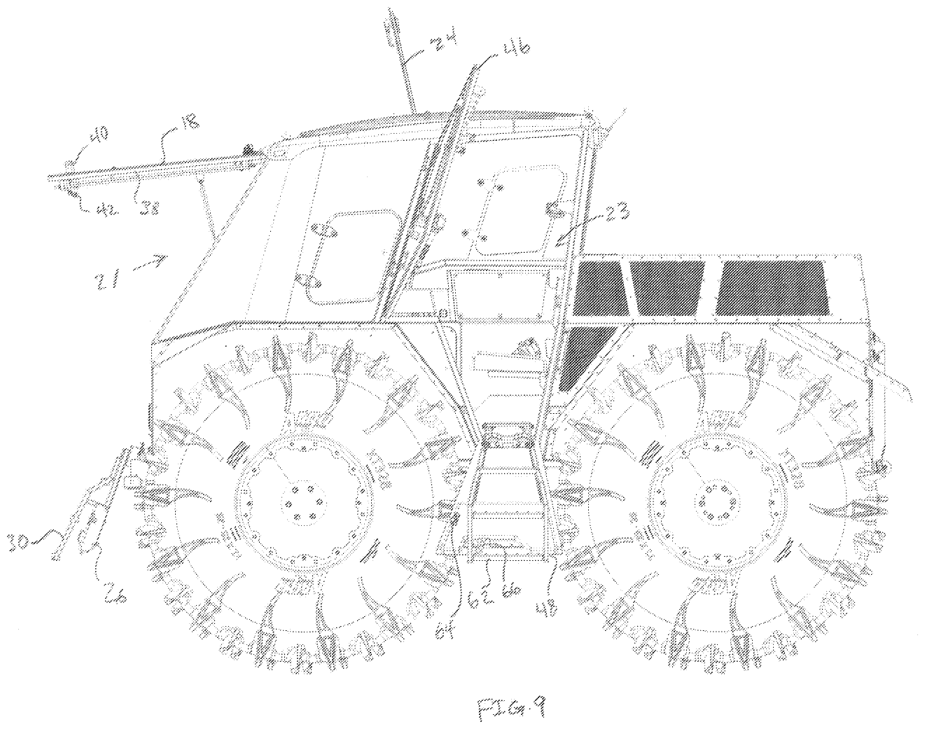

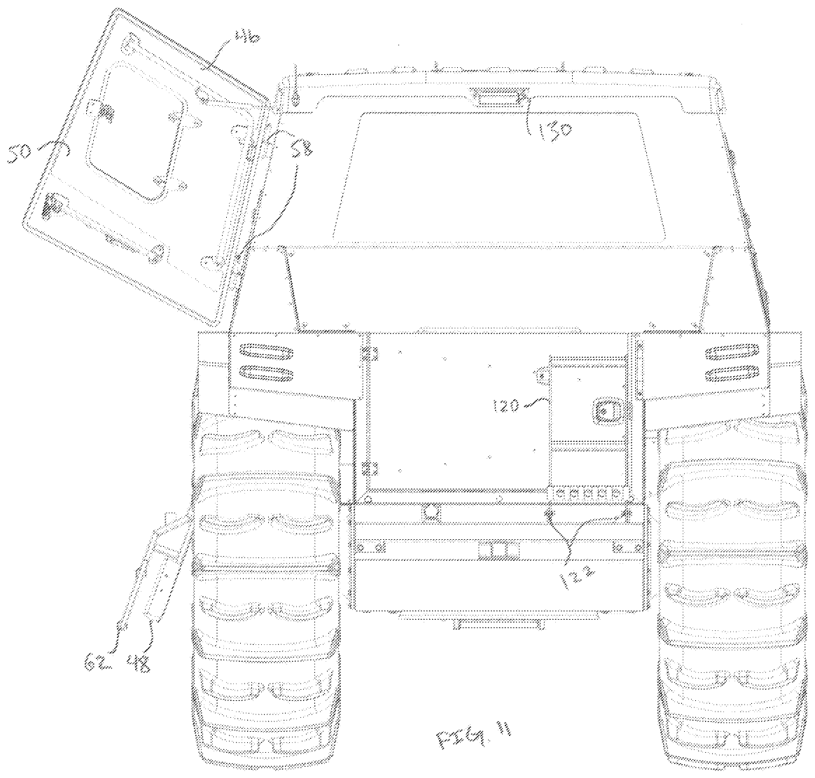

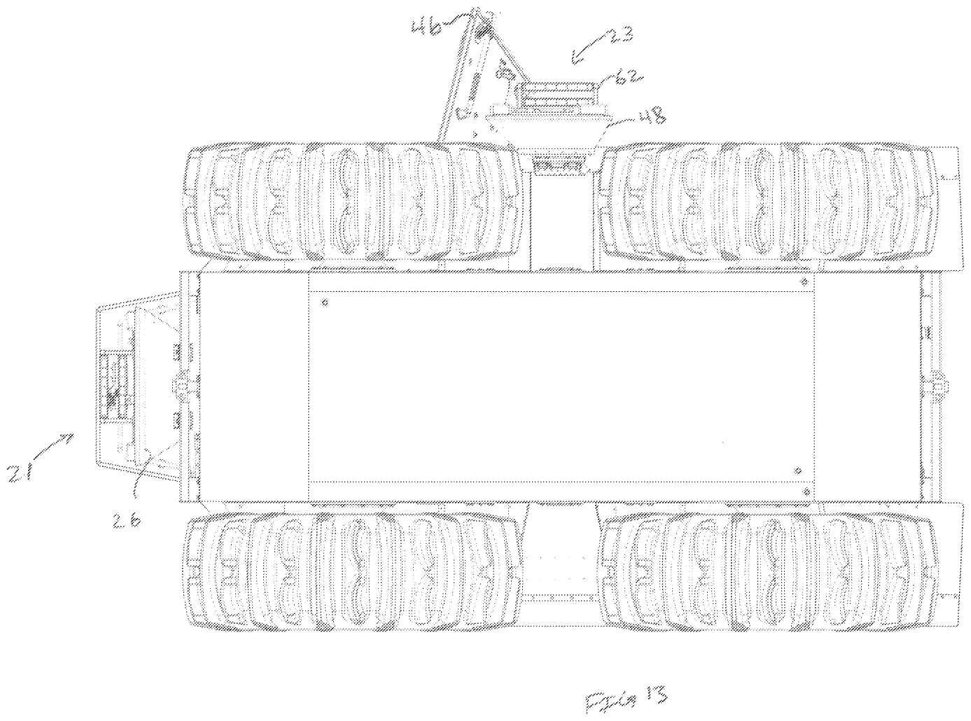

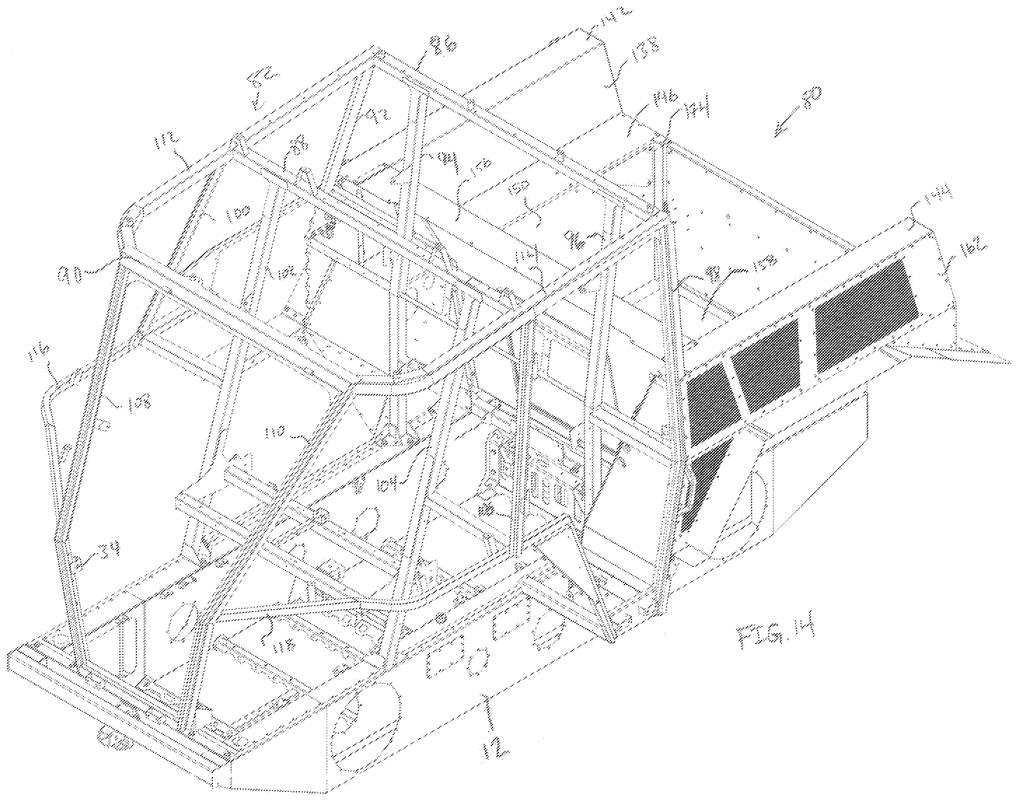

As will be further appreciated with reference to FIGS. 8-13, in some embodiments, the vehicle 10 includes a front entry access 21, a side entry access 23, and a roof hatch 24. In some embodiments, the front entry access 21 includes the front windshield 18 which opens upwardly and lower door 26 which opens downwardly about front door hinges 28. As further shown in FIGS. 8 and 9, the lower door 26 includes front ladder 30. The front ladder 30 has steps, stairs, rungs, or similar, and permits an occupant to enter or exit the vehicle 10 from the front of the vehicle 10. Further, in some embodiments, the lower door 26 includes one or more front door latches 32, for example on lateral sides of the lower door 26, which selectively engage with the door retention members 34. As illustrated in FIGS. 8 and 14, in some embodiments, the door retention members 34 are affixed to a frame member of the cab portion 16. In some embodiments, the front windshield 18 has one or more windshield frame members 38. Further, in some embodiments, a front latch handle 40 attached to one or more of the windshield frame members 38. In some embodiments, the front exterior latch handle 40 permits access to the inside of the vehicle 10 by first raising the front windshield 18 about its hinges, then actuating the front door latche(s) 32, and subsequently lowering the lower door 26 by rotating it about front door hinges 28. In some embodiments, the front door latche(s) 32 are triggered via lower door actuator member 44 (FIG. 8). With reference to FIG. 9, opposite the exterior latch handle 40 is an interior latch member 42, which may be actuated from inside of the cab to selectively open the front windshield 18.

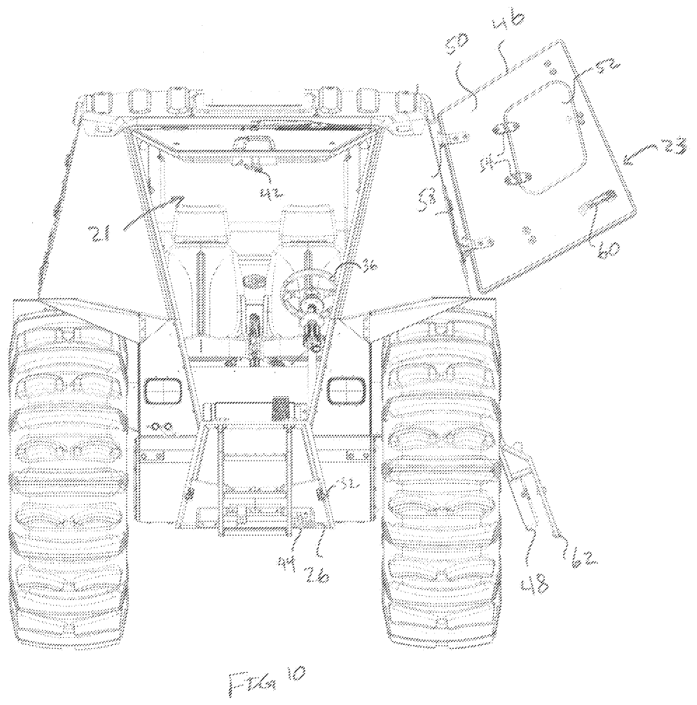

With further reference to FIGS. 8-13, in some embodiments, the side entry access 23 includes side upper door 46 and side lower door 48. Side upper door portion 46 includes upper door window 50. In some embodiments, the side upper door 46 further includes side hinged window 52, which can be pivotably opened via hinges 54 (FIG. 10). Side upper door 46 swings about upper door hinges 58 and includes side exterior latch handle 60. Side lower door 48 includes side ladder 62, which can be utilized to board vehicle 10, has steps, stairs, rungs, or similar. Further, in some embodiments, the side lower door 48 includes one or more side door latches 64, for example on a lateral side of the side lower door 48, which selectively engages with the door retention member. In a fashion similar to that of the front entry access 21, in some embodiments, the side exterior latch handle 60 permits access to the inside of the vehicle 10 by first opening the side upper door 46 about upper door hinges 58, then actuating the side (lower) door latch 64, and subsequently lowering the lower door 26 by rotating it about front door hinges 28. In some embodiments, and similar to that of the front lower door 26, the side door latch 64 is actuated by way of side lower door actuator member 66 (FIG. 9).

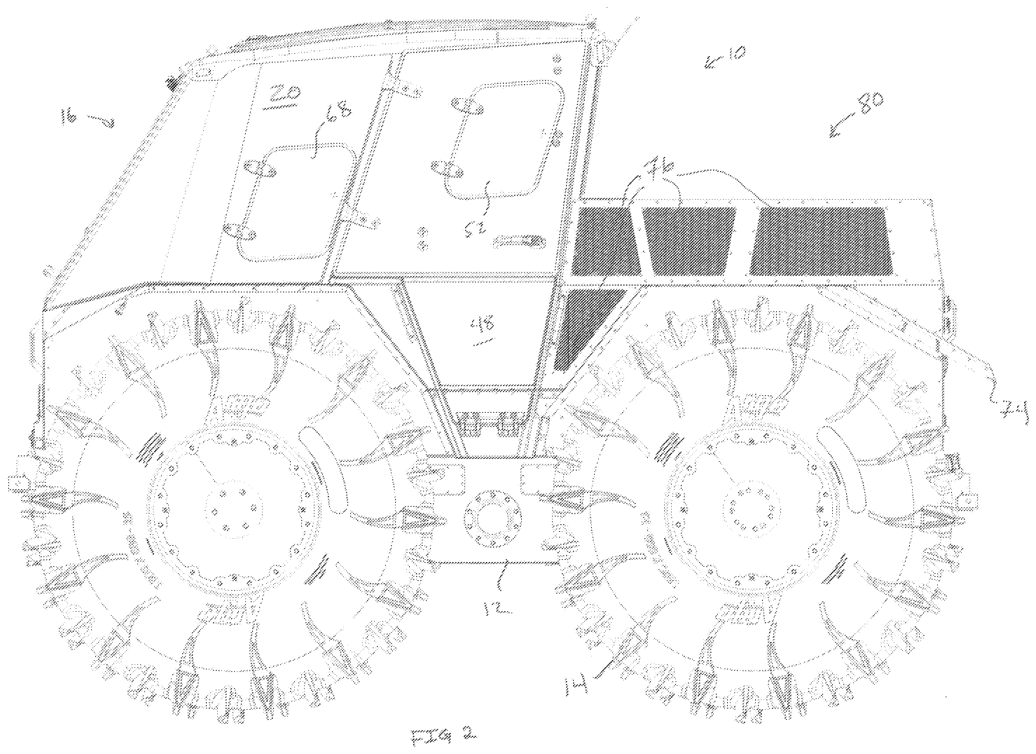

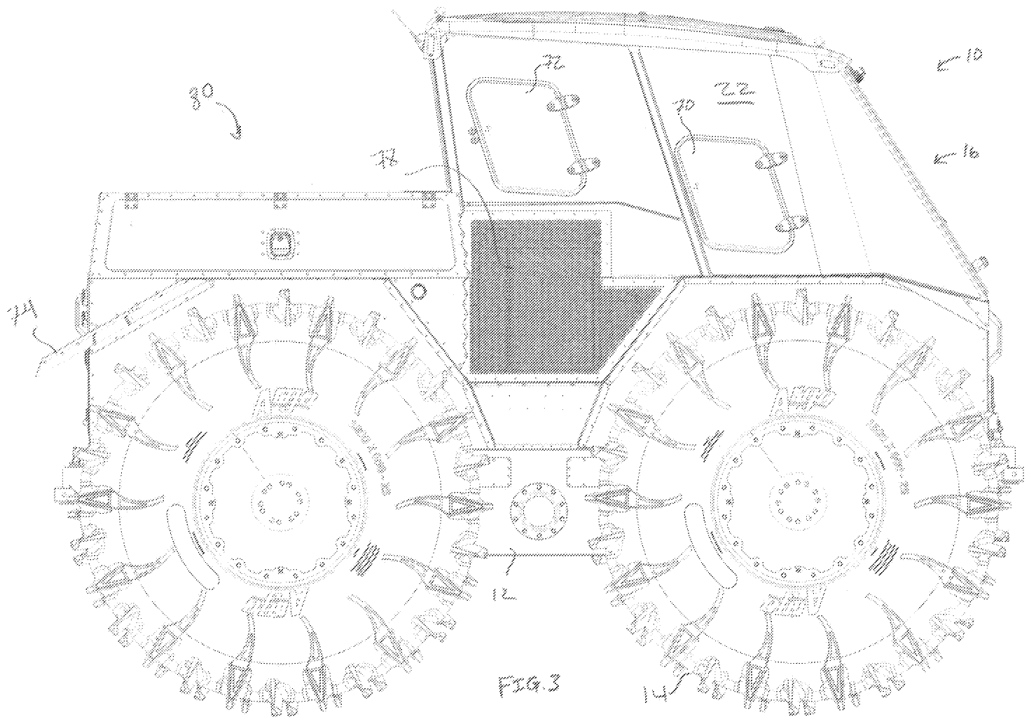

Referring again to FIGS. 2 and 3, in some embodiments, the cab portion 16 includes one or more openable side windows, for example front left side window 68, front right side window 70, and rear right side window 72. As shown, each of these openable side windows 68, 70, 72, as well as side hinged window 52 located on side upper door 46 is openable about its respective hinges. As also shown in FIGS. 2 and 3, in some embodiments, the vehicle 10 includes air exchange vents 76, 78 (left and right, respectively). The air exchange vents 76, 78 permit air flow into and out of portions of the vehicle 10 for engine combustion air, cooling air for the radiator, etc. In some embodiments, some or all of the air exchange vents 76, 78 are made from a mesh screen material that inhibits particulates from entering and allows for air to pass through the material. As shown, in some embodiments, left air exchange vents 76 are located rearwardly of the cab 16. Further in some embodiments, right air exchange vents 78 are located forward of a box portion 80.

Referring to FIGS. 1-6, vehicle 10 includes a splash shield 74. The splash shield 74 reduces splashing of mud or water onto upper portions of the vehicle 10, for example when the vehicle 10 is floating on the water. In some embodiments, a portion of the splash shield 74 is attached to the side lower door 48 (FIG. 1). As shown in FIG. 8, when the side lower door 48 is opened, the portion of the splash shield 74 attached thereto now faces the opposite way (i.e. the upward facing portion of the portion attached to the side lower door 48 faces downward when the side lower door 48 is opened as in FIG. 8). The splash shield 74 can be affixed to the vehicle 10 in any suitable way, for example by rivets or other fasteners or adhesive. In some embodiments, the splash shield 74, or portions thereof, are formed from a flexible material (e.g., rubberized material) and/or durable plastic such as HDPE (high-density polyethylene) so that it resists damage if it is bumped by an object.

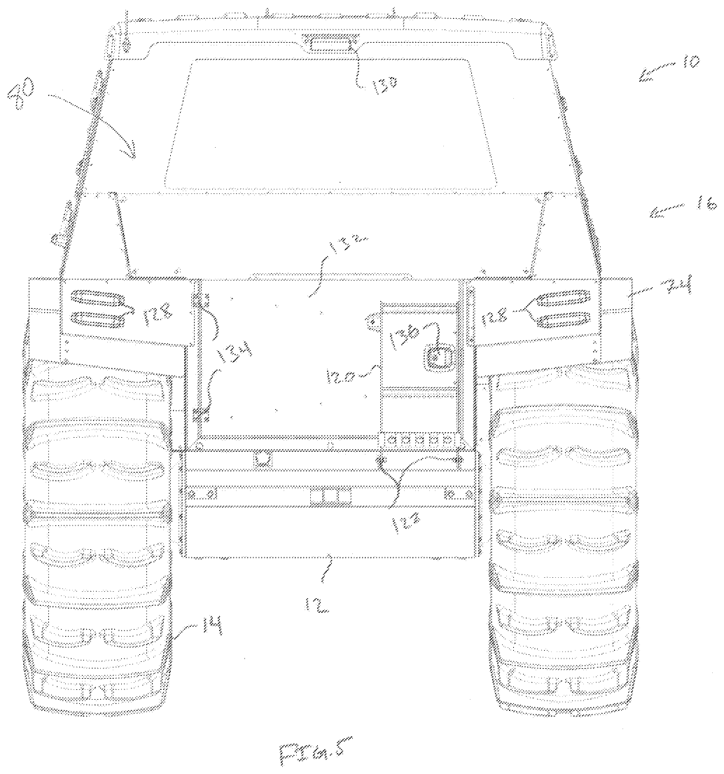

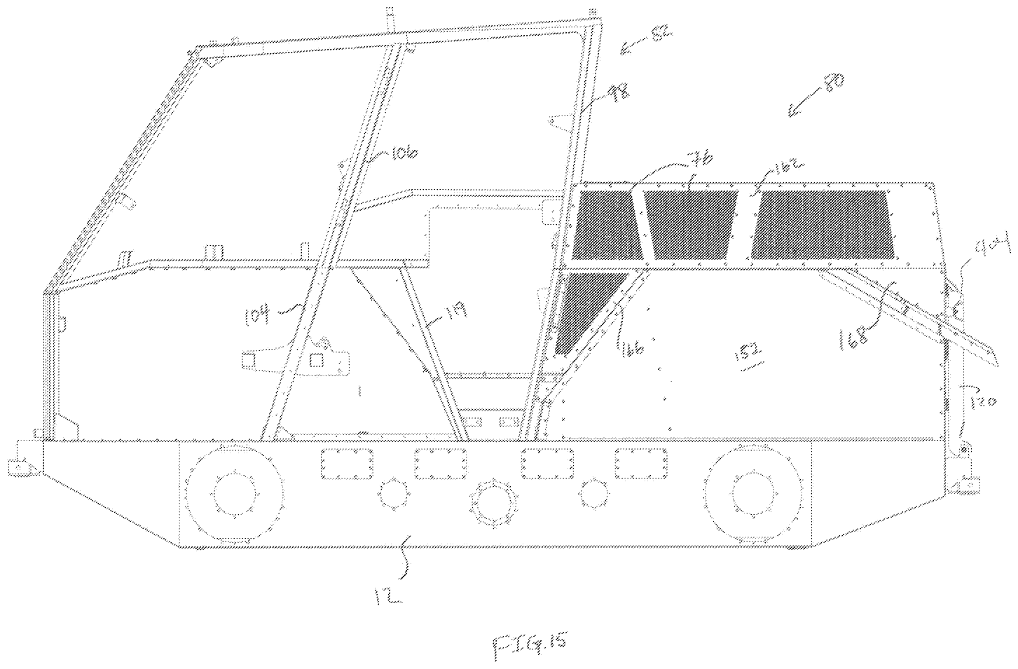

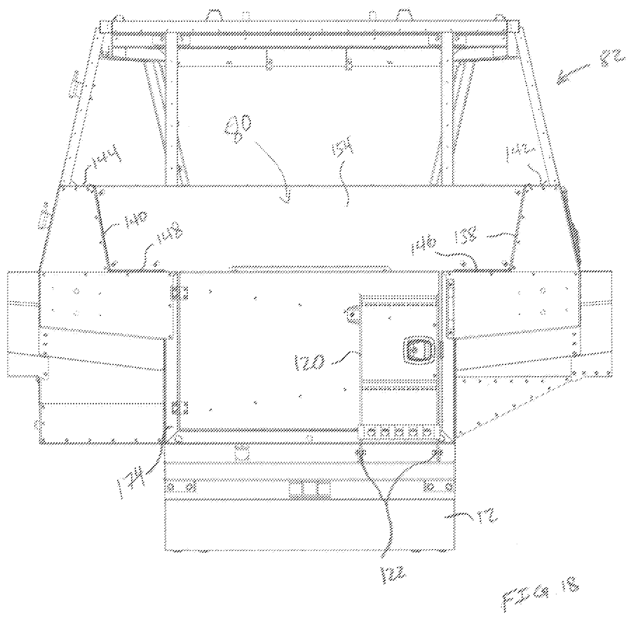

As shown in at least FIGS. 5, 11, 15, 16, 18, and 19, in some embodiments, the vehicle 10 includes a rear ladder 120 (shown in the retracted configuration). The rear ladder 120 is pivotable about rear ladder hinges 122 (FIG. 18), permitting the rear ladder 120 to extend downwardly and, thereby, facilitating easier access to the box portion 80. The rear ladder 120 has steps, stairs, rungs, or similar. In some embodiments, the rear ladder 120 must be in a down configuration in order to open the tailgate 132. In some embodiments, for example as shown in FIG. 15, the rear ladder 120 is held in an up configuration by way of retaining member 404. The retaining member 404 can be a magnet, catch-style latch, or any suitable retainer. In some embodiments, the retaining member 404 is supported by a grommet.

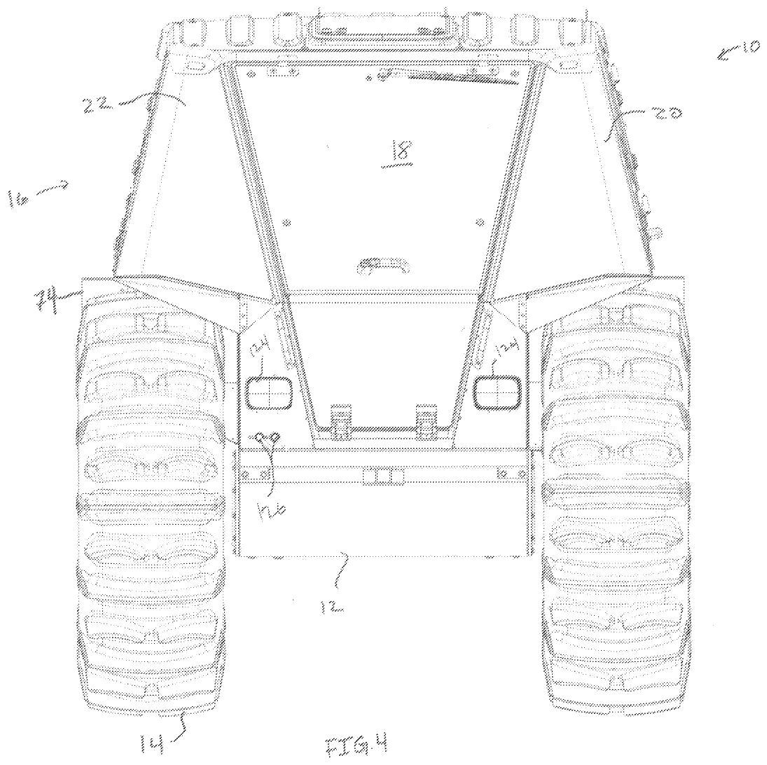

With regard to FIG. 4, in some embodiments, the vehicle 10 includes one or more front lights 124, which can aid in driving at night or in reduced visibility, for example. In some embodiments, one or more of the front lights 124 comprise high intensity LEDs in a white color. Further, in some embodiments, the vehicle 10 includes electrical ports 126. The electrical ports 126 can be located on a front of the vehicle 10, side, rear, or various combinations thereof, and permit charging of one or more batteries of the vehicle 10, or, for example, to power an accessory winch.

With regard to FIG. 5, in some embodiments, the vehicle 10 includes one or more rear lights 128, for example, brake lights in the color red, which may be LED or any suitable type. Further, a box illumination light 130 is shown, which can be selectively activated by an operator to help illuminate the box portion 80. In some embodiments, the vehicle 10 includes a tailgate 132. As shown, the tailgate 132 swings open about tailgate hinges 134 and can be opened by actuating tailgate latch handle 136.

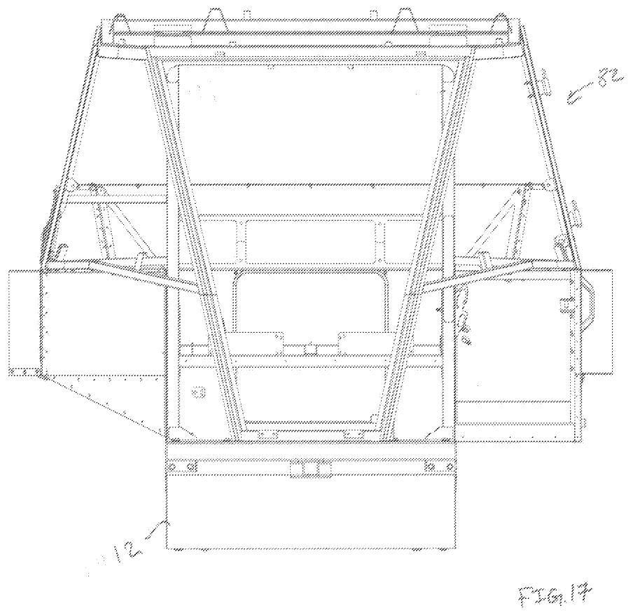

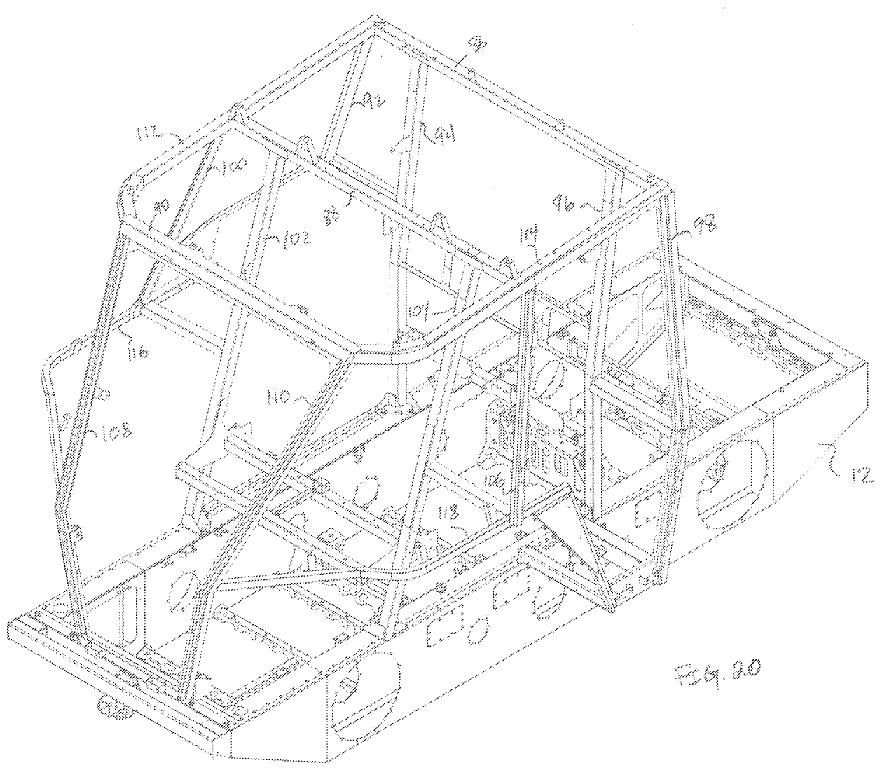

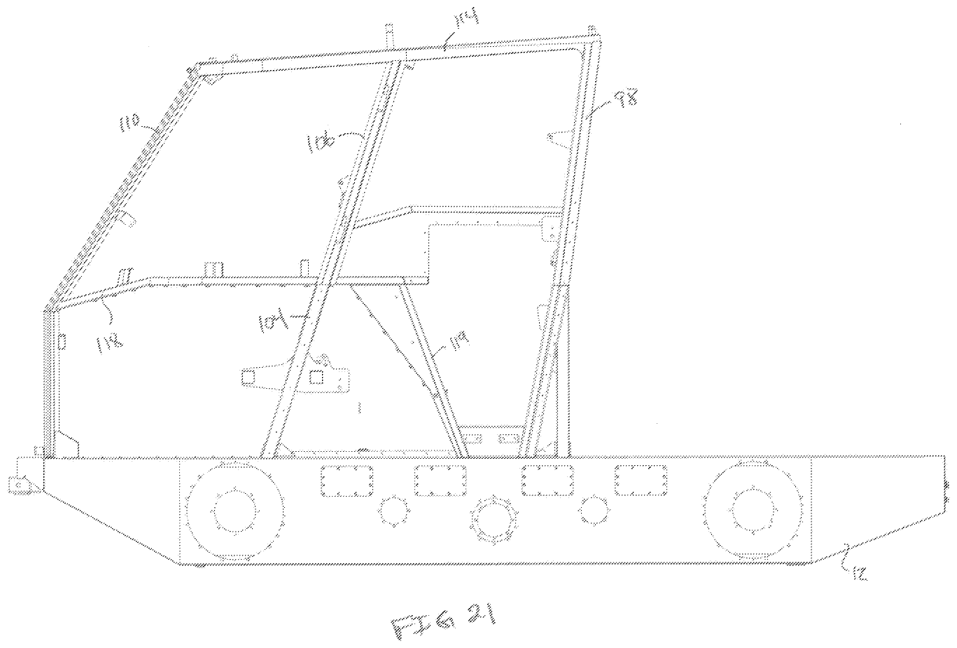

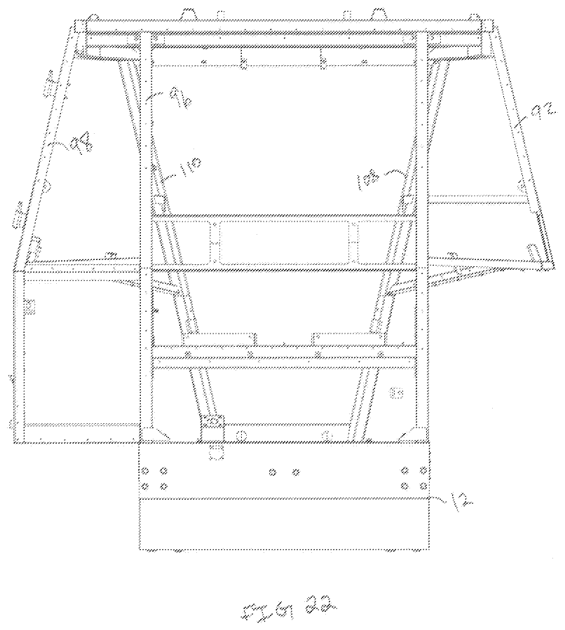

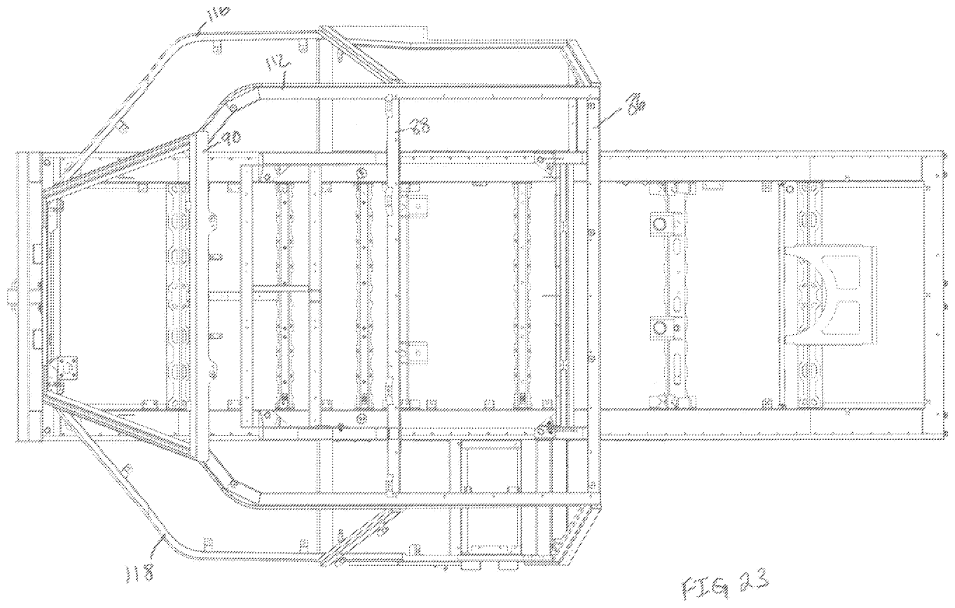

Turning to FIGS. 14-23, the cab 16 includes a plurality of frame members 82. The frame members 82 may be welded and/or otherwise fastened to one another to form a cab structure which, in some embodiments, is attached to a chassis 12, for example with fasteners such as bolts, welding, or in any other suitable fashion. In some embodiments, the frame members 82 include a rear transverse frame member 86, intermediate transverse frame member 88, front transverse frame member 90, right-rear exterior upright frame member 92, right-rear interior upright frame member 94, left-rear interior upright frame member 96, left-rear exterior upright frame member 98, right-intermediate exterior upright frame member 100, right-intermediate interior upright frame member 102, left-intermediate interior upright frame member 104, left-intermediate exterior upright frame member 106, right-front upright frame member 108, left-front upright frame member 110, right upper longitudinal frame member 112, left upper longitudinal frame member 114, right intermediate frame member 116, left intermediate frame member 118, and/or left lower door frame member 119.

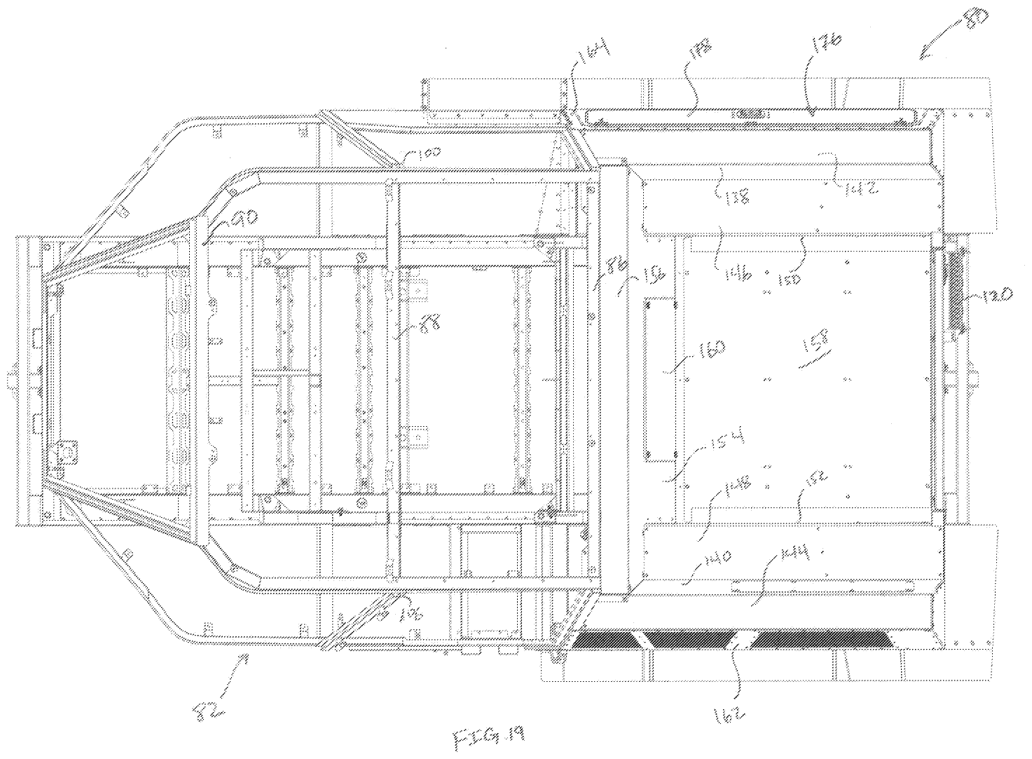

With further reference to FIGS. 14-16 and 18-19, in some embodiments, as mentioned previously, the vehicle 10 includes a box portion 80. Box portion 80 comprises a plurality of panels. Each of the panels may be formed from one or more pieces of material and/or multiple panels may be formed from a single piece of material, for example, by bending. Further, the panels may be comprise, for example, sheet metal, polymer, composites. The panels may be affixed to one another and/or the chassis 12, for example, by fasteners (e.g., bolts, screws, rivets), adhesive, or in any other suitable way. The panels include inside side panels and outside side panels. In some embodiments, for example as shown in FIG. 19, the panels include right upper inside panel 138, left upper inside panel 140, right top panel 142, left top panel 144, right intermediate inside panel 146, left intermediate inside panel 148, right lower panel 150 and left lower panel 152. As illustrated at least in FIGS. 14, 18, and 19, in some embodiments, the right upper inside panel 138 slopes downwardly from the right top panel 142 to the right intermediate inside panel 146. In some embodiments, the left upper inside panel 140 slopes downwardly from the left top panel 144 to the left intermediate inside panel 148. In some embodiments, one or more of the right top panel 142, left top panel 144, right intermediate inside panel 146, and left intermediate inside panel 148 are generally horizontal. The panels may further include front box panel 154, front top panel 156, and box floor panel 158. As shown in FIG. 19, in some embodiments, the front box panel 154 includes removable front box panel portion 160, which can be removed to provide access, for example, to various driveline components, air filter, engine oil dipstick, or other components.

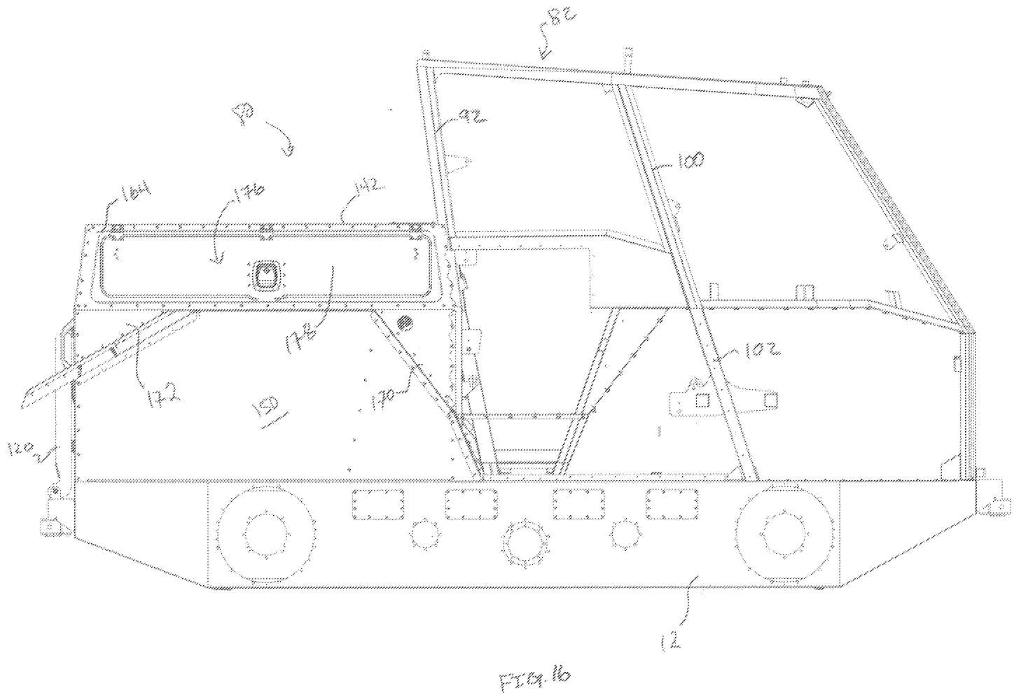

In some embodiments, for example as shown in FIGS. 15 and 16, the panels include a left outside upper panel 162, right outside upper panel 164, forward left outside lower panel 166, rearward left outside lower panel 168, forward right outside lower panel 170, and rearward right outside lower panel 172. One or more of the left outside upper panel 162, right outside upper panel 164, forward left outside lower panel 166, rearward left outside lower panel 168, forward right outside lower panel 170, and rearward right outside lower panel 172, has cutouts for the air exchange vents, such as left air exchange vents 76 shown, for example, in FIGS. 2 and 15. In some embodiments, the air exchange vents 76 are located only on the left side of the vehicle 10.

As shown, for example, in FIGS. 14 and 18, the box portion 80 includes rear box portion frame 174. In some embodiments, the rear box portion frame 174 provides structural support for various panels, which are attached to the rear box portion frame 174, for example by fasteners such as rivets. The rear box portion frame 174 can be made in any suitable way, for example as a welded subassembly formed from box tubing. The rear box portion frame 174 may be affixed to the chassis 12, for example, via one or more fasteners such as bolts and nuts. In some embodiments, the right intermediate inside panel 146, left intermediate inside panel 148, right lower panel 150, and left lower panel 152 are attached to the rear box portion frame 174 via fasteners, such as rivets.

With regard to FIGS. 16 and 19, in some embodiments, the box portion 80 includes a storage locker 176. The storage locker 176 can be accessed by opening locker door 178. As shown, the storage locker 176 is located at least partially between the right outside upper panel 164 and the right upper inside panel 138. As further shown, right top panel 142 extends over the storage locker 176. The storage locker 176 can have other configurations. For example, it can be located on the left side of the vehicle. In some embodiments, both the left and right sides have storage lockers.

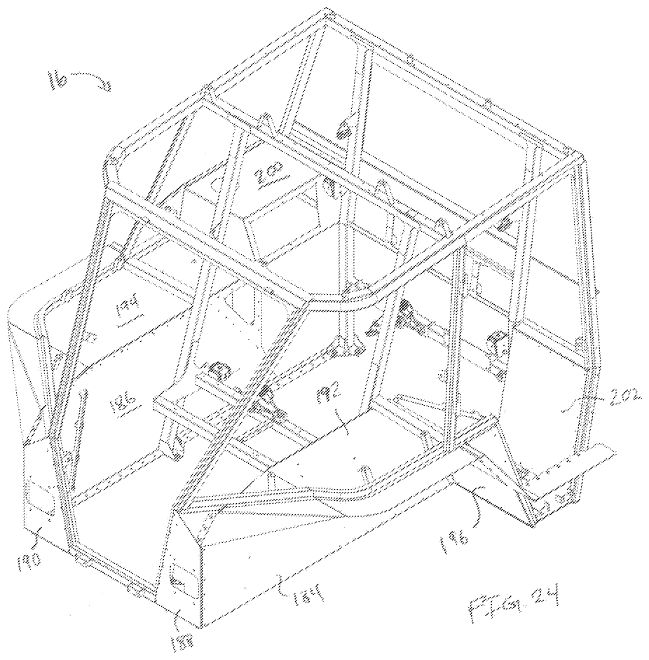

Turning to FIG. 24, in some embodiments the cab portion 16 includes one or more panels, such as left lower cab panel 184, right lower cab panel 186, left front-facing cab panel 188, right-front facing cab panel 190, left upper fender panel 192, right upper fender panel 194, left wheel panel 196, right wheel panel (not shown in FIG. 24), right cab closeout panel 200, and left rear door closeout panel 202. In some embodiments, the right cab closeout panel 200 has one or more openings to permit cooling airflow through the panel.

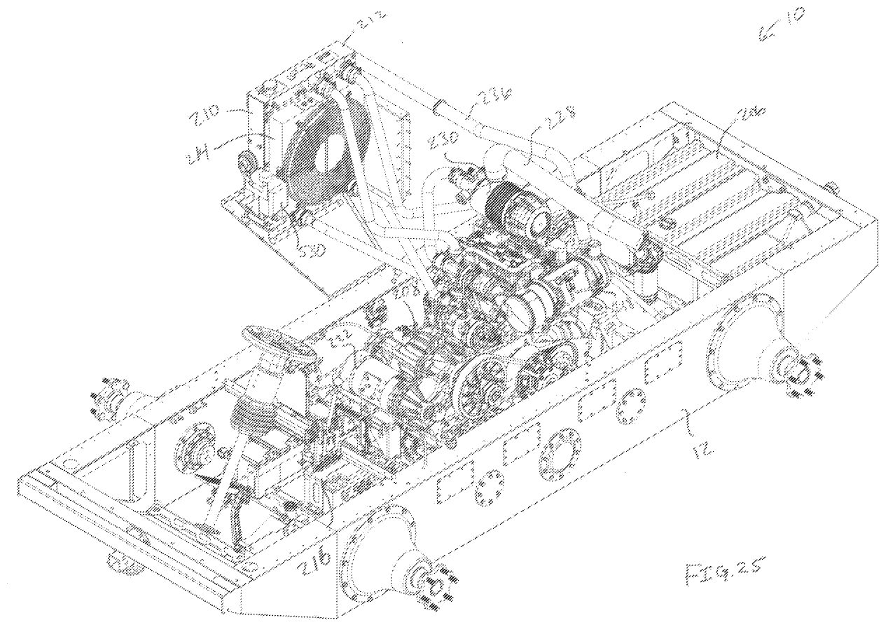

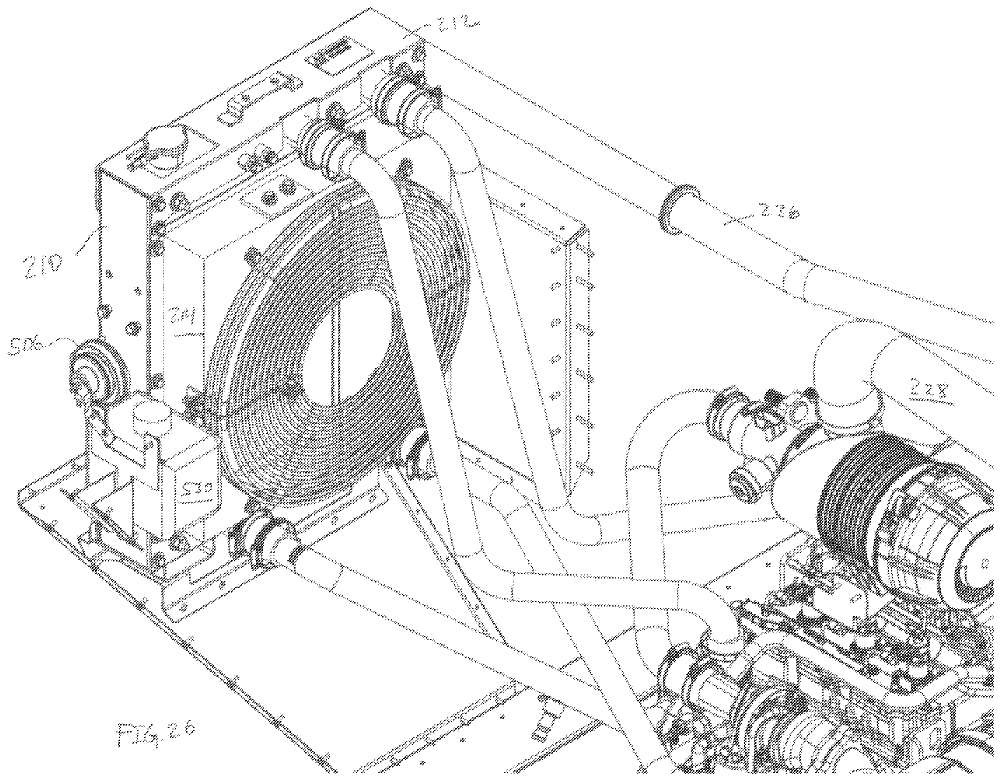

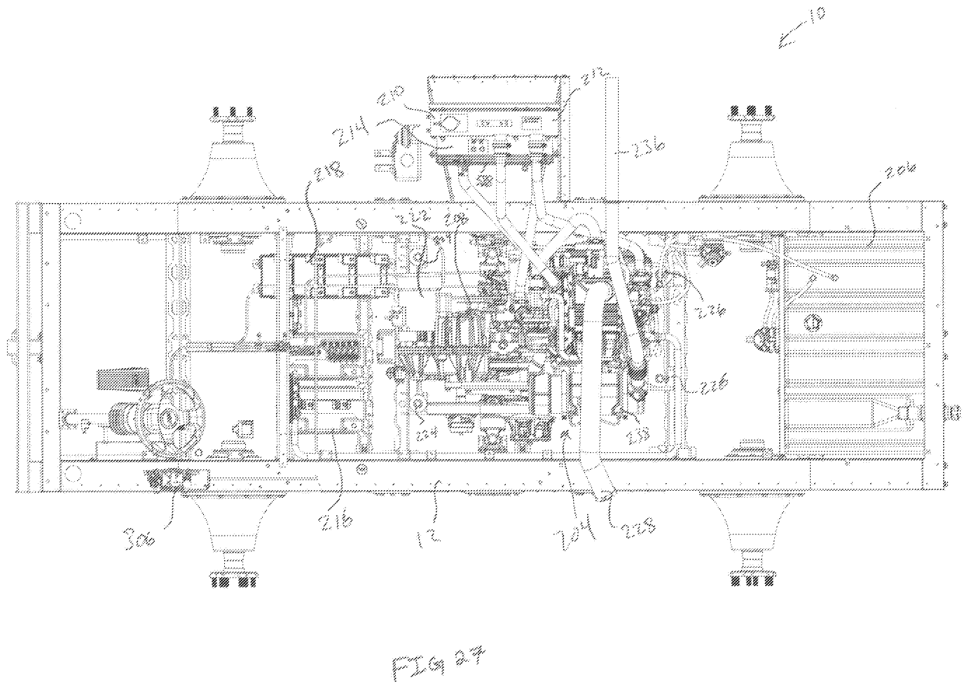

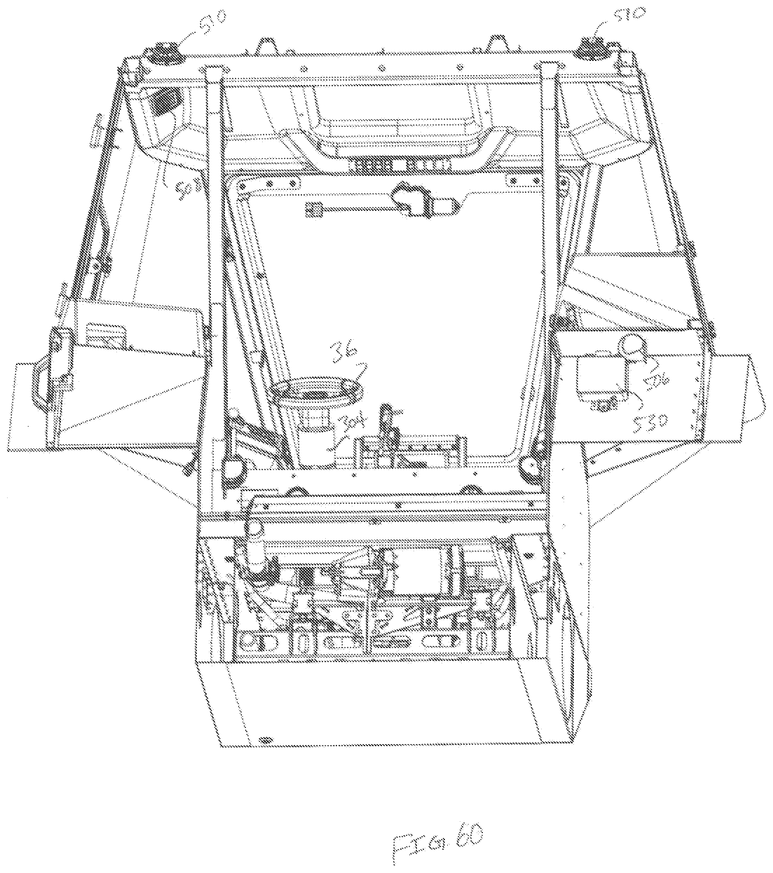

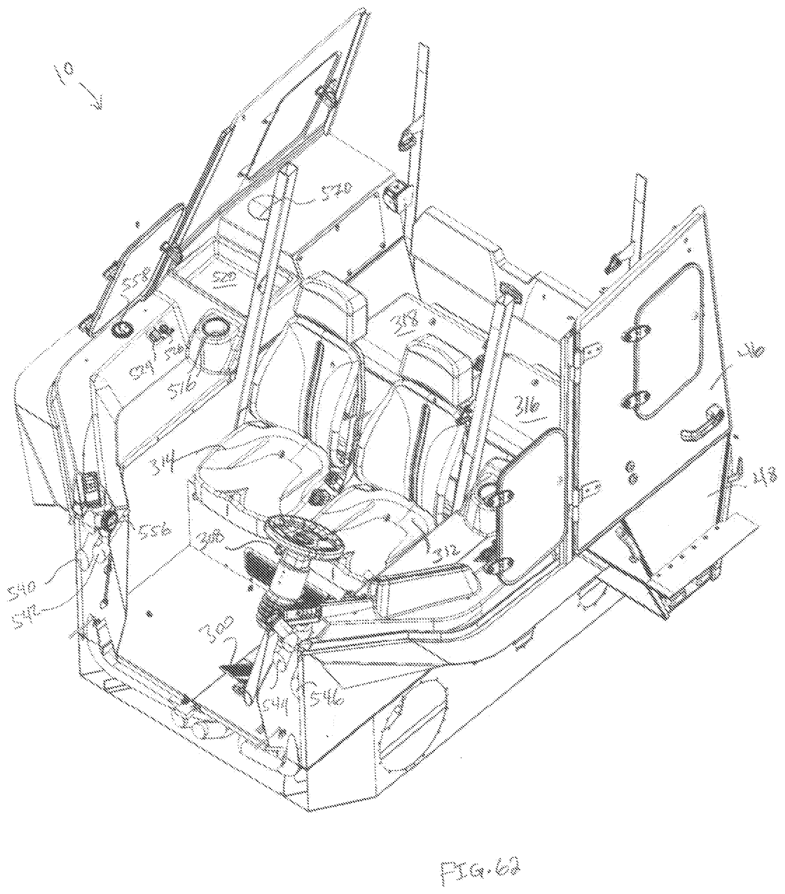

FIGS. 25-27 show various driveline and cooling components, among other things, situated in or on the chassis 12 of the vehicle 10. In some embodiments, the vehicle 10 includes a prime mover 204 (FIG. 27), such as a combustion gas or diesel engine, or electric motor, fuel tank, range transmission 208, radiator 210, intercooler 212, cooling fan 214, starter battery 216, and steer battery 218. A coolant reservoir 530 (see also FIG. 60) holds extra coolant for the radiator 210 and acts as an expansion chamber. Coolant can be added to the coolant reservoir 530 from inside the cab portion 16 via service access panel 570 (FIG. 62). As shown in FIG. 25, the cooling fan 214 is on the inside (closer to the longitudinally extending centerline of the vehicle) of the radiator 210, however, in some embodiments, the cooling fan 214 is on the outside of the radiator 210.

The prime mover 204 is utilized to propel the vehicle; the range transmission 208 can include a plurality of gears and/or chains and may include one or more ranges such as low-range forward, hi-range forward, neutral, reverse, and/or park. As shown, the range transmission 208 is located in front of the prime mover 204 and attached to the prime mover 204 via one or more fasteners such as bolts and nuts. In some embodiments, the range transmission 208 and prime mover 204 are installed in the chassis 12 as an assembly.

With further regard to intercooler 212, in some embodiments, it is an air-to-air intercooler utilized in conjunction with a turbocharger (supercharger or other compressor). The intercooler 212 cools the air coming out of the turbocharger before it is routed into the engine intake.

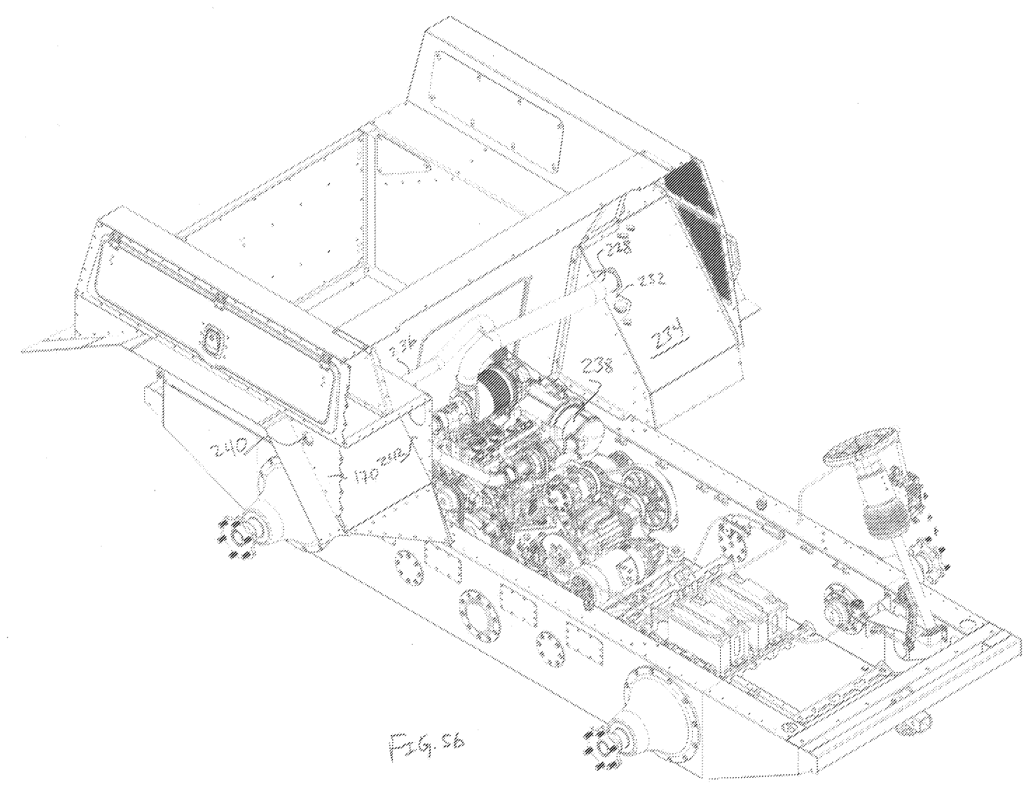

In some embodiments, the vehicle 10 includes a combustion air inlet hose 228, which leads to an air cleaner 230. In some embodiments, the combustion air inlet hose 228 is attached to inlet hose holder member 232 (FIG. 56). As shown in FIG. 56, the inlet hose holder member 232 comprises a piece of sheet metal or injection molded plastic with at least one orifice. In turn, in some embodiments, the inlet hose holder member 232 is located adjacent to left forward-facing fender panel 234 and intake air is provided via the left air exchange vents 76. In some embodiments, a portion of the inlet hose holder member 232 is formed from a single piece of material with left intermediate inside panel 148 (FIG. 19) and a retaining portion is added to the inlet hose holder member 232 to support the combustion air inlet hose 228.

With additional reference to FIGS. 25-27 and 56, in some embodiments, the vehicle 10 includes an engine exhaust hose 236 which routes engine exhaust out of the vehicle 10. As shown, the engine exhaust hose 236 is attached to a muffler 238. Exhaust exits the engine exhaust hose 236 on the right side of the vehicle 10 at exhaust port 240 (FIG. 56). In some embodiments, the engine exhaust hose 236 is routed through forward right inside lower panel 242 and forward right outside lower panel 170.

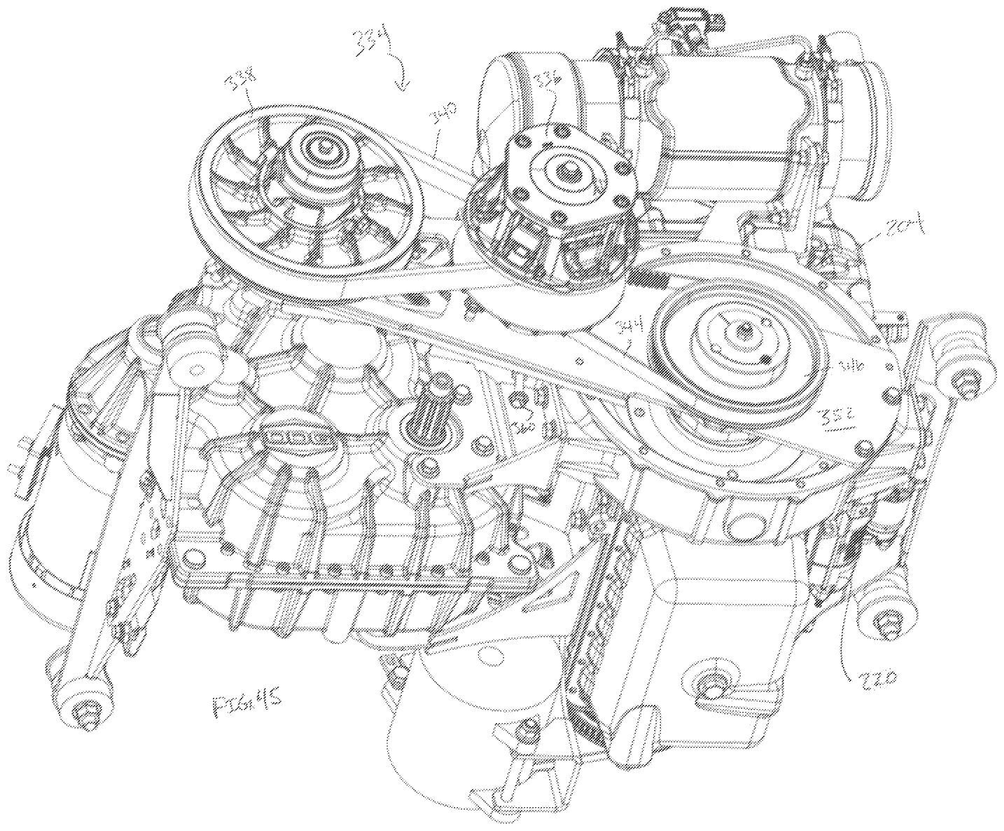

The vehicle 10 may include one or more starter batteries 216 (FIG. 27) which provide electrical power to the engine starter 220 (FIG. 45) to facilitate starting of the engine. In some embodiments, the vehicle 10 may further include one or more steer batteries 218 that provide electrical power to a steering motor 222. In turn, the steering motor 222 is attached to the range transmission 208. In some embodiments, the vehicle 10 can turn (e.g., zero-turn) by utilization of the steering motor 222 without the prime mover 204 (e.g., engine) running. In some embodiments, the range transmission 208 is of the type described in U.S. Pat. No. 6,454,031, to Szymkowiak, the contents of which are herein incorporated by reference. However, any suitable range transmission 208 may be utilized. In some embodiments, the range transmission 208 includes hi-range forward, low-range forward, park, reverse, and neutral. In some embodiments, the range transmission 208 includes hi-range forward, low-range forward, park, and reverse. In some embodiments, the range transmission 208 includes one forward range, one reverse range, and park. In some embodiments, the range transmission 208 includes hi-range forward, low-range forward, neutral, and reverse.

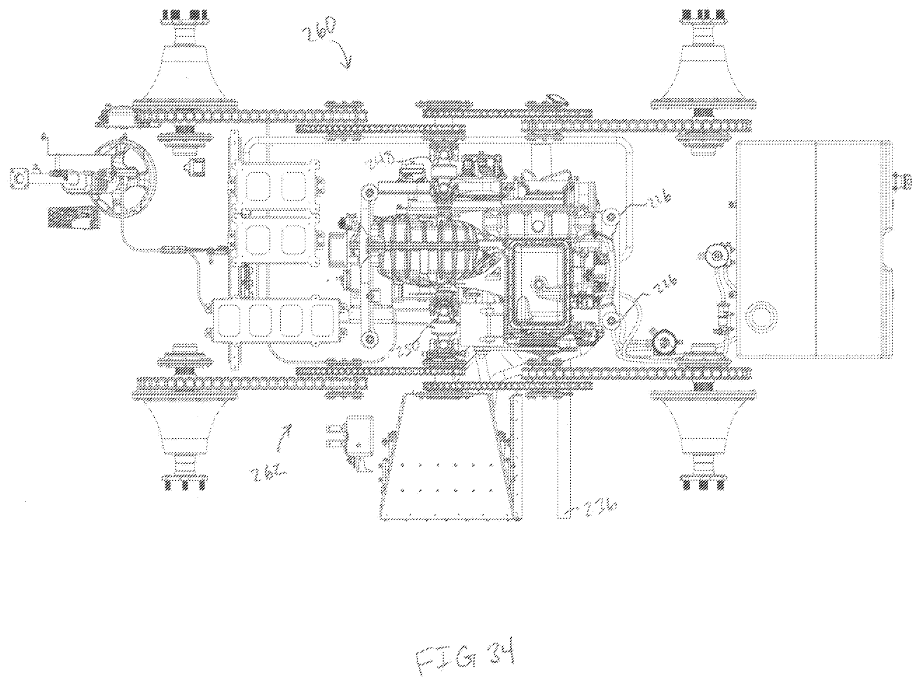

As shown in FIG. 27, the range transmission 208 is mounted to the chassis 12 via at one or more transmission mounting locations 224, for example with vibration dampers (e.g., elastomeric members such as rubberized isolators), which reduce spread of vibrations from the range transmission 208 (as well as the prime mover 204 and CVT system) into the chassis 12. As further shown in FIGS. 27 and 34, the prime mover 204 is mounted to the chassis 12 via at one or more prime mover mounting locations 226, for example with vibration dampers (e.g., elastomeric members such as rubberized isolators), which reduce spread of vibrations from the prime mover 204 (as well as the range transmission 208 and CVT system) into the chassis 12.

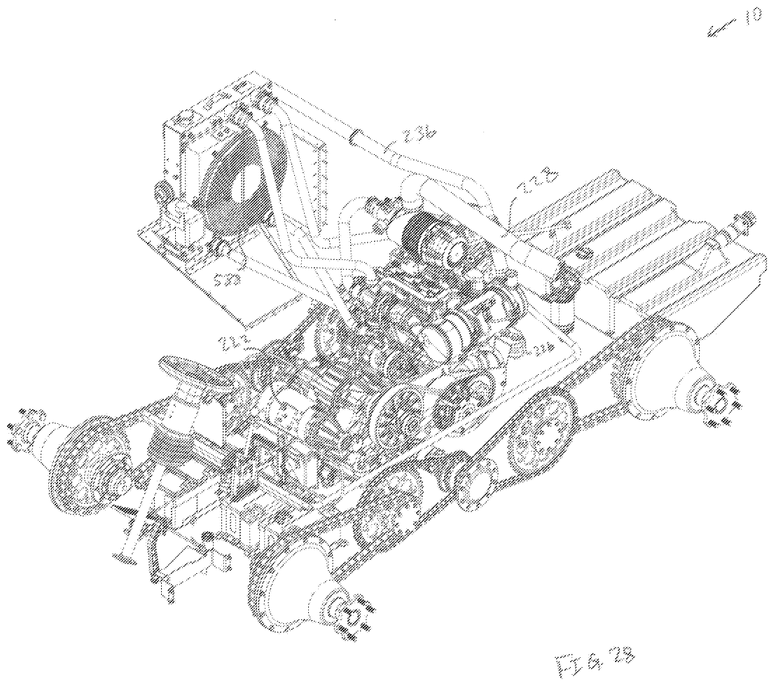

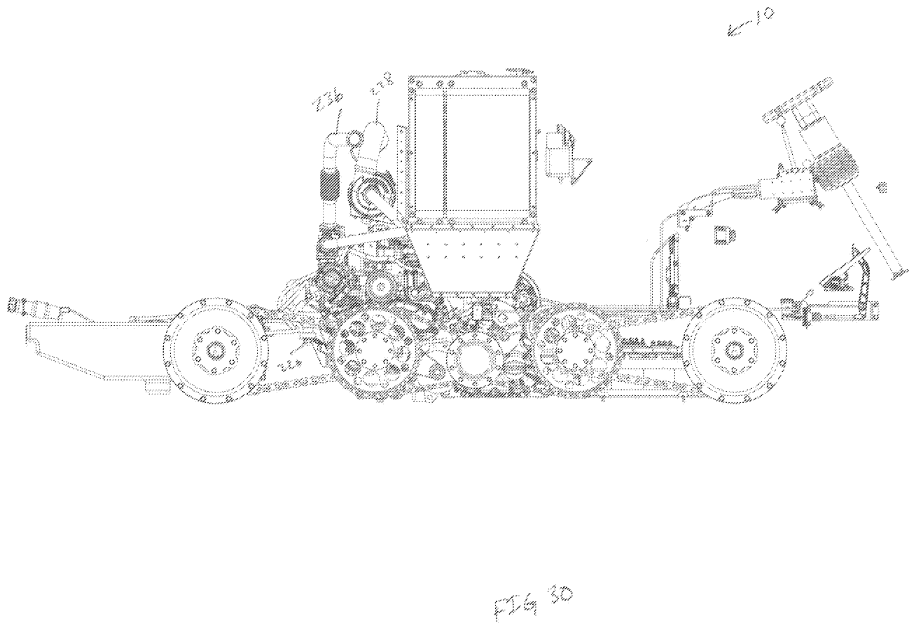

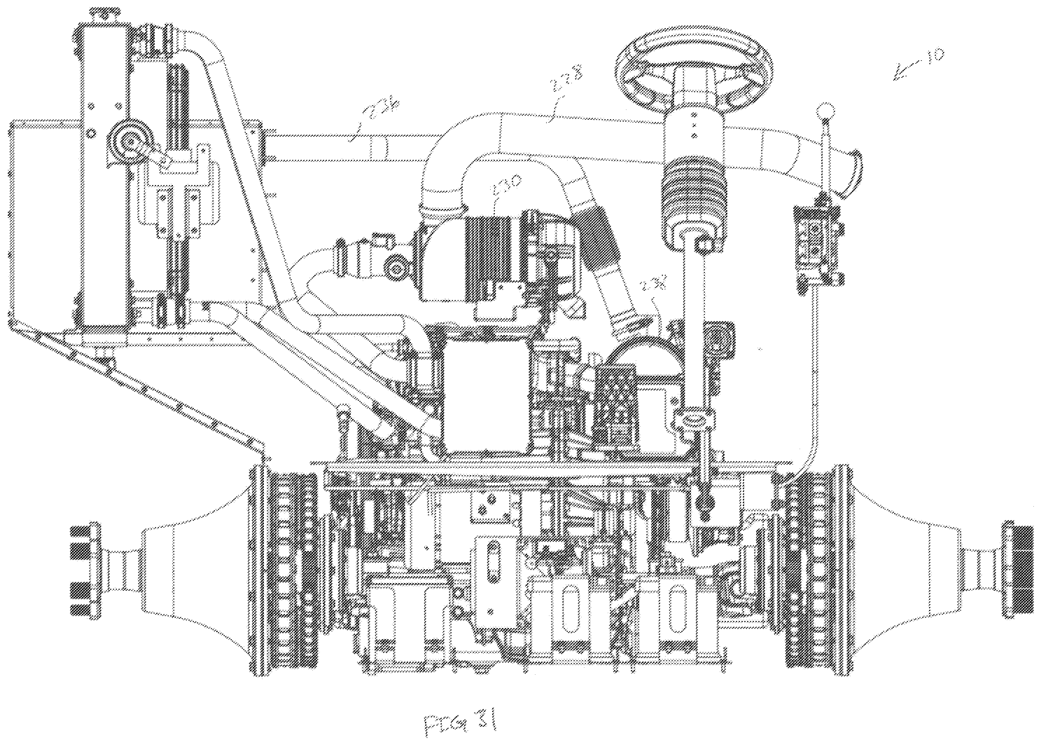

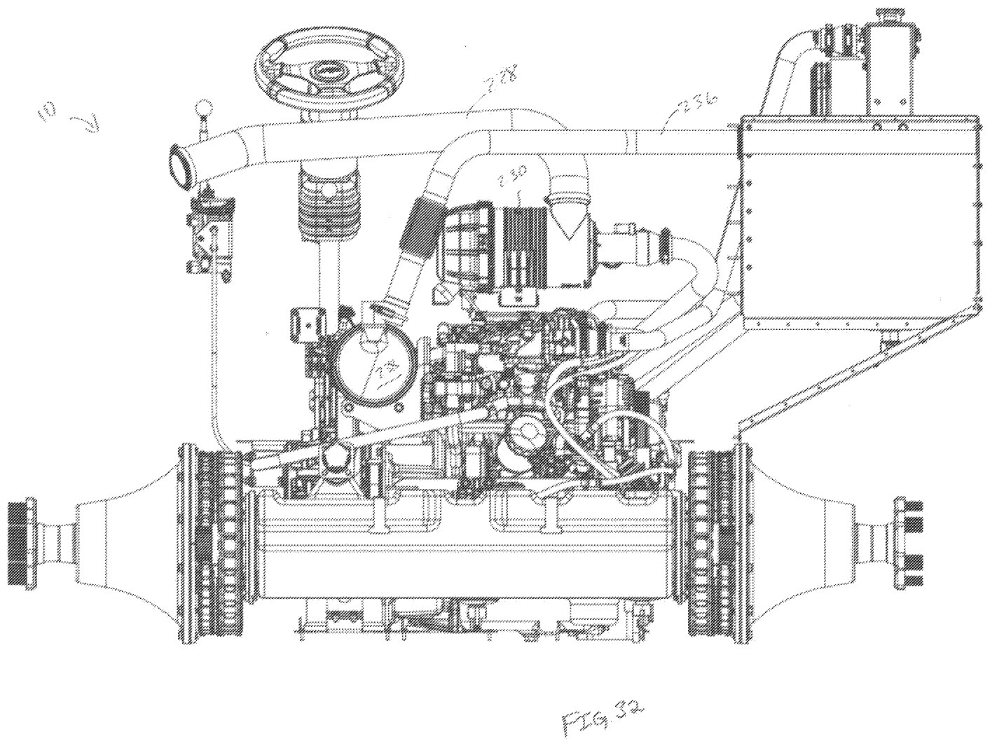

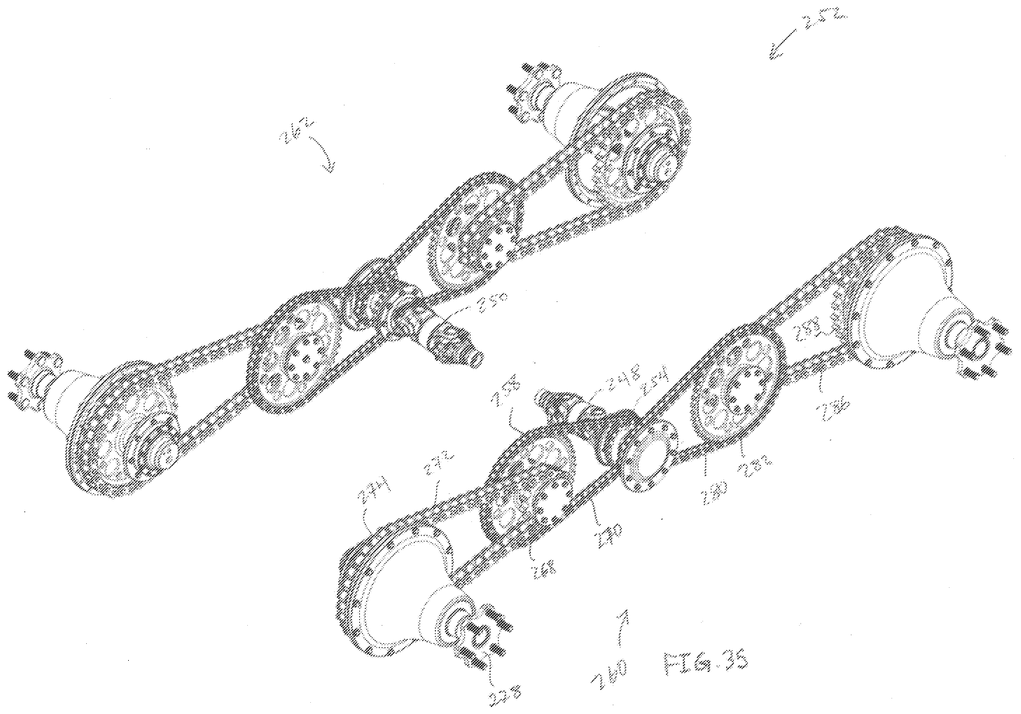

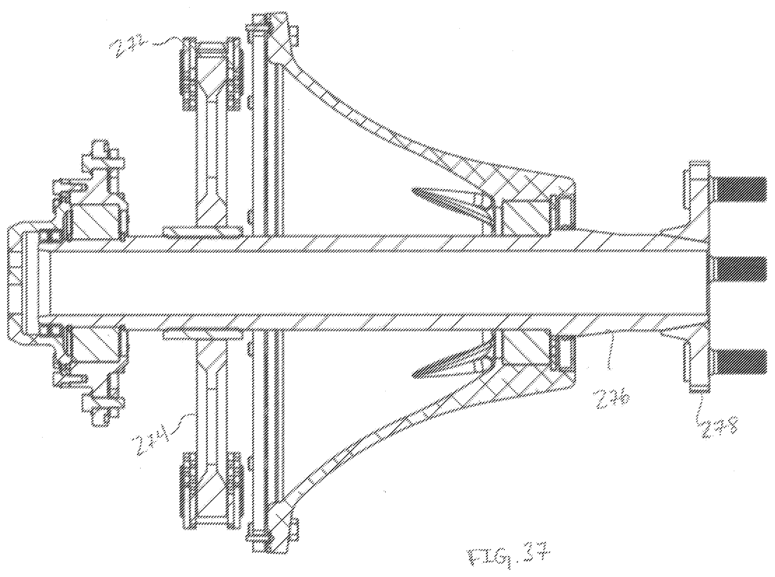

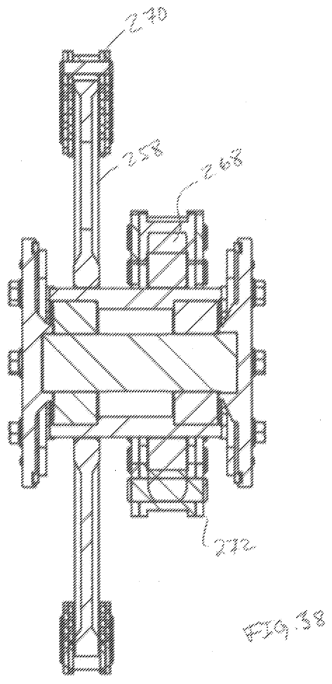

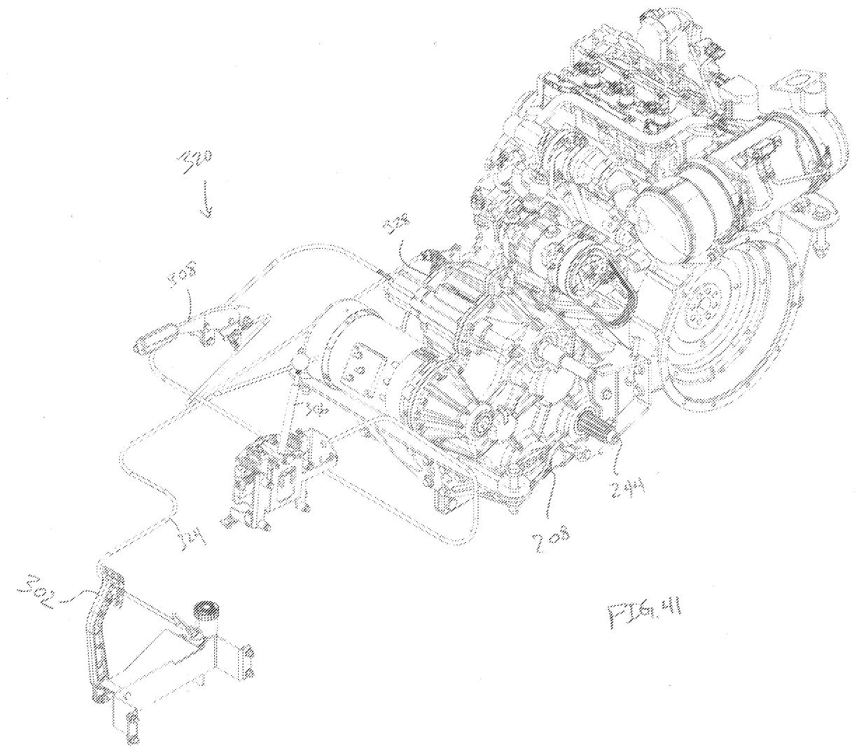

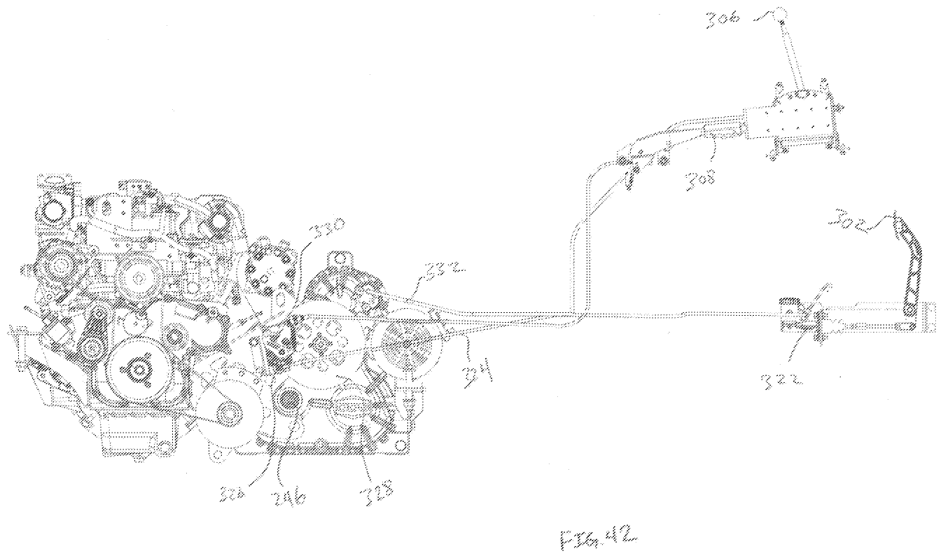

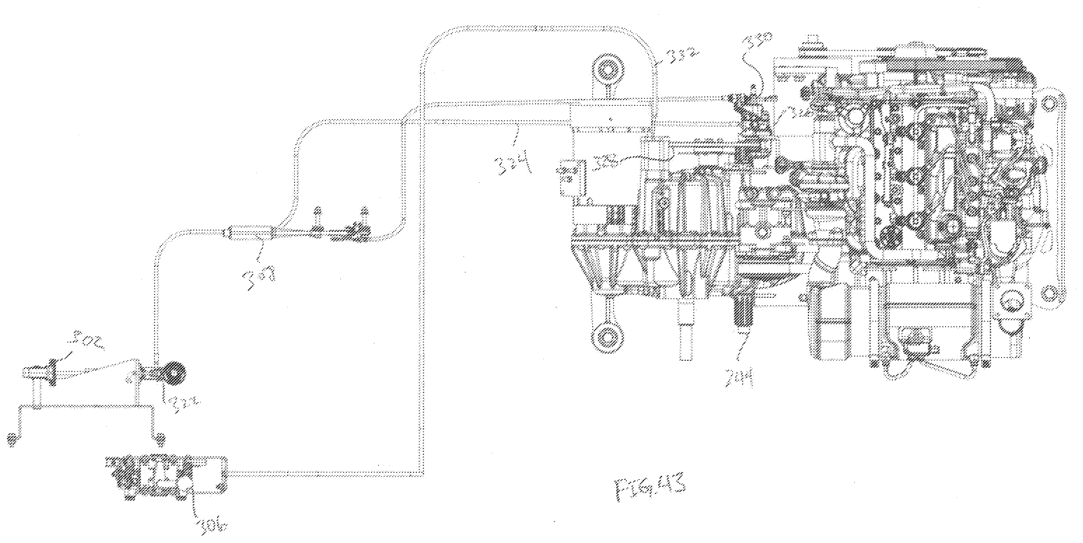

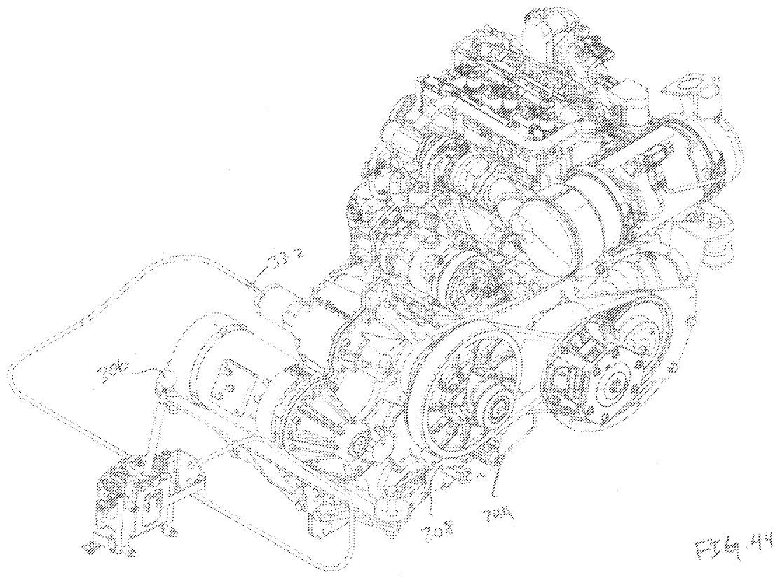

With regard to FIGS. 28-45, in some embodiments, the range transmission 208 has a left output shaft 244 and a right output shaft 246 (FIGS. 41-44). As shown in FIG. 34, the left output shaft 244 is rotatably coupled to the left drive shaft 248 and the right output shaft 246 is rotatably coupled to the right drive shaft 250. In some embodiments, the left drive shaft 248 and the right drive shaft 250 each comprise one or more universal joints. As shown in FIG. 35, for example each of the left drive shaft 248 and the right drive shaft 250 include two universal joints.

In some embodiments, a driveline 252 (as shown for example in FIG. 35) includes a left driveline 260 and a right driveline 262. As shown for example in FIG. 35, in some embodiments, the left driveline 260 is a mirror-image of the right driveline 262. In this case, only the left driveline 260 will be discussed in detail, however, it should be understood that the right driveline 262 will have a similar configuration.

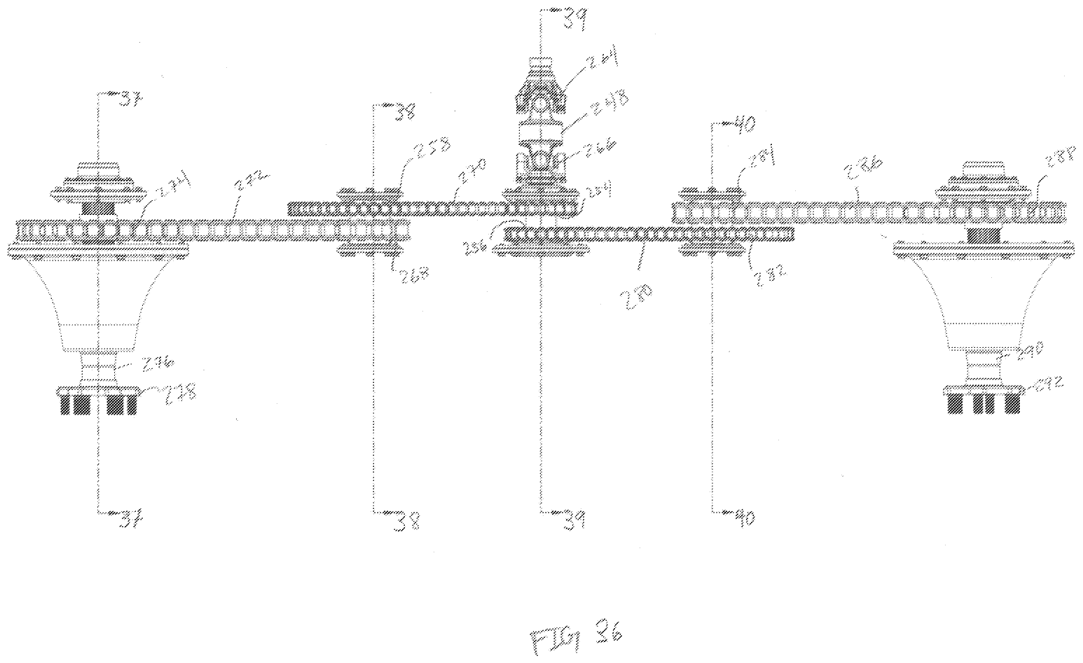

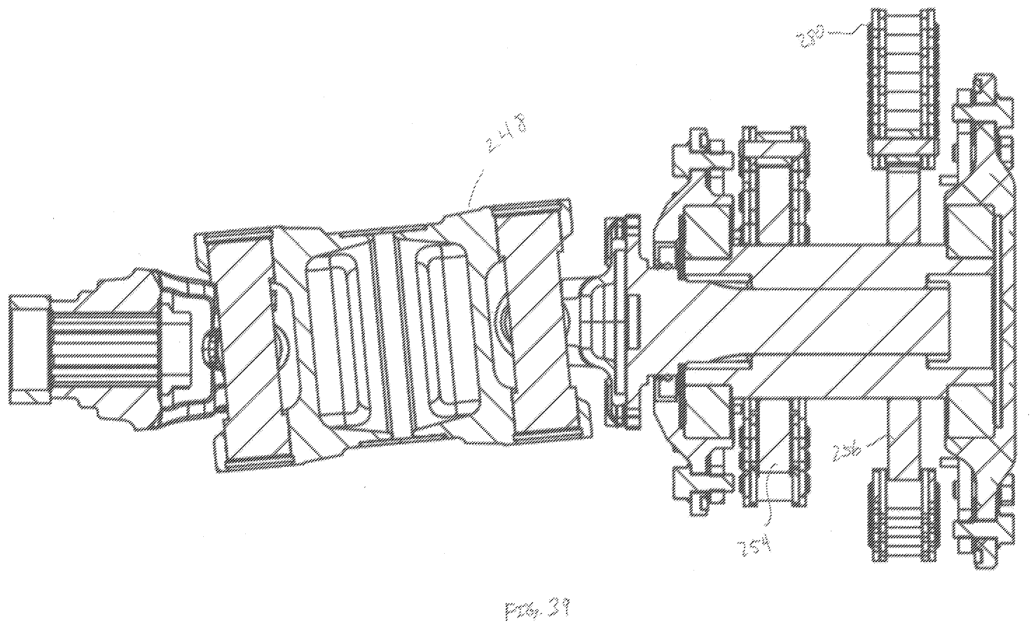

Turning then to the left driveline 260, as shown in FIG. 36, the left drive shaft 248 includes an inboard universal joint 264 and an outboard universal joint 266. In some embodiments, the left driveline 260 further includes a first primary drive sprocket 254 and a second primary drive sprocket 256 (FIG. 39), a first forward idler sprocket 258, and a second forward idler sprocket 268. The first primary drive sprocket 254 and a second primary drive sprocket 256 are rotatably coupled together (they rotate together) such that when the left drive shaft 248 rotates, it also rotates the first primary drive sprocket 254 and a second primary drive sprocket 256. In turn, the first primary drive sprocket 254 is linked to first forward idler sprocket 258 via first forward chain 270. The first forward idler sprocket 258 and second forward idler sprocket 268 are rotatably coupled together such that when the first forward chain 270 drives the first forward idler sprocket 258, the second forward idler sprocket 268 is also rotated. In some embodiments, there is a size difference between the respective sprockets which acts as a reduction.

With further regard to the left driveline 260, in some embodiments, it further includes a second forward chain 272 linking the second forward idler sprocket 268 to forward driven sprocket 274. In turn, the forward driven sprocket 274 is rotatably coupled to front axle shaft 276, for example via splines or a keyway and key. In some embodiments, the second forward chain 272 is made from a larger size chain than the first forward chain 270 considering loads in the second forward chain 272 may be greater than those in the first forward chain 270. In some embodiments, the first forward chain 270 is a #80 roller chain and the second forward chain 272 is a #120 roller chain. Further, in some embodiments, a front wheel hub 278 is affixed to front axle shaft 276, for example by welding. Other suitable sized or style chains (or gears in lieu of chains) may be used.

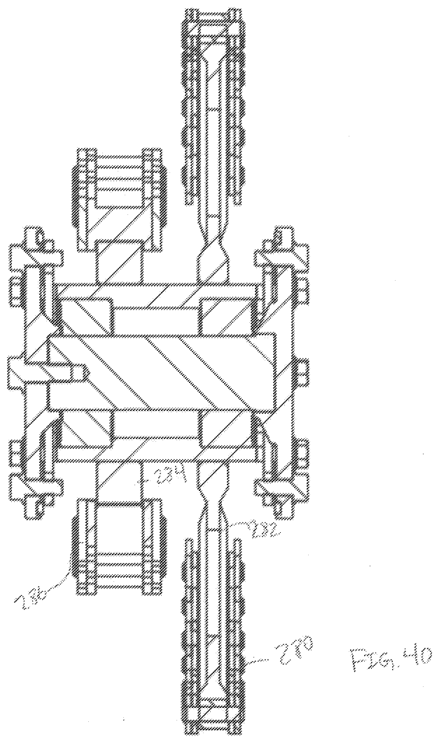

With further reference to FIGS. 35-40, in some embodiments, the left driveline 260 includes first rearward chain 280, first rearward idler sprocket 282, second rearward idler sprocket 284 (FIG. 40), second rearward chain 286, and rearward driven sprocket 288. Such components rearward of the left drive shaft 248 are similar to those forward of the left drive shaft 248 described previously, however, the relative location of some of the components is different. By way of example, and as shown for example in FIG. 35, the second rearward chain 286 is inboard of the first rearward chain 280 whereas the second forward chain 272 is outboard of the first forward chain 270. As further shown, the rearward driven sprocket 288 is rotatably coupled to rear axle shaft 290, which is affixed to rear wheel hub 292.

Turning to FIGS. 41-44, an embodiment of the brake and shifter assemblies is shown. The brake system 320 includes a brake pedal 302, master cylinder 322, hydraulic line 324, slave cylinder 326, and brake disc 328. An operator may stop or slow the vehicle 10 by depressing the brake pedal 302 such that fluid in the hydraulic line actuates the slave cylinder 326 to act against the brake disc 328.

As further shown, in some embodiments, the brake system 320 further includes a hand brake 308 and hand brake cable 330. The hand brake 308 actuates the hand brake cable 330 to act on the brake disc 328 when desired (e.g., as a parking brake and/or emergency brake). In at least some embodiments, the hand brake cable 330 has a sheath surrounding the movable portion of the cable.

Additionally, a range selector 306 has attached thereto a sheathed range selector cable 332, which is attached to a portion of the range transmission 208.

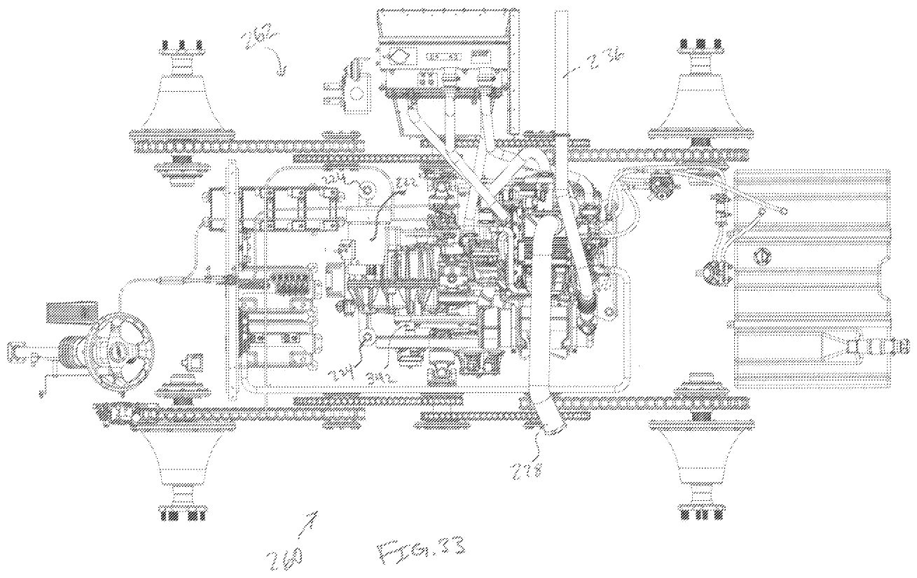

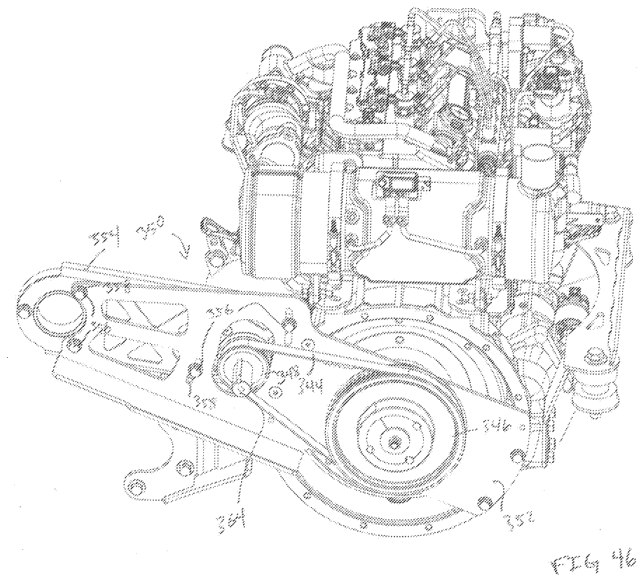

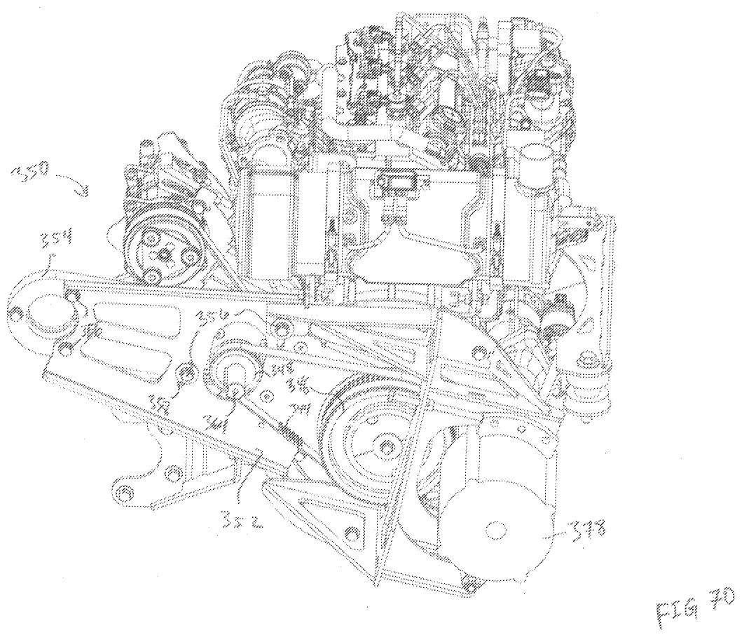

With regard to FIGS. 45-48 and 69-72, in some embodiments, the vehicle 10 includes a continuously variable transmission 334 or CVT. The CVT includes a drive clutch 336, a driven clutch 338, and a CVT belt 340. The driven clutch 338 is rotatably coupled to power input shaft 342 (FIG. 33) of the range transmission 208, thereby providing power to the range transmission 208. In turn, the drive clutch 336 is coupled to the prime mover 204 via one or more drive belts 344. In some embodiments, the drive belt(s) 344 are toothed. As shown in FIGS. 46 and 70, the drive belt 344 extends from a crank pulley 346, which is driven by the engine crankshaft. The drive belt 344 further extends around clutch pulley 348. In this way, the drive belt 344 transfers power from the prime mover 204 to the drive clutch 336.

In some embodiments, the drive clutch 336 rotates 2.857 times (80 tooth crank pulley and 28 tooth clutch pulley) for each rotation of the crank pulley 346—resulting in a 2.857:1 RPM increase between the crank pulley 346 and drive clutch 336. In this way, a diesel engine can be utilized for the prime mover 204 and the diesel engine will operate at its standard RPM range (as opposed to a higher RPM range for a gasoline/spark ignition engine). Additionally, the 2.9:1 RPM increase facilitates greater optimization of the CVT for CVT shifting, and also reduces the torque felt by the CVT belt 340 in comparison to a system where the drive clutch rotates at engine RPM. In some embodiments, however, the ratio is between 2:1 and 4:1 and, in some embodiments, between 2.5:1 and 3.3:1.

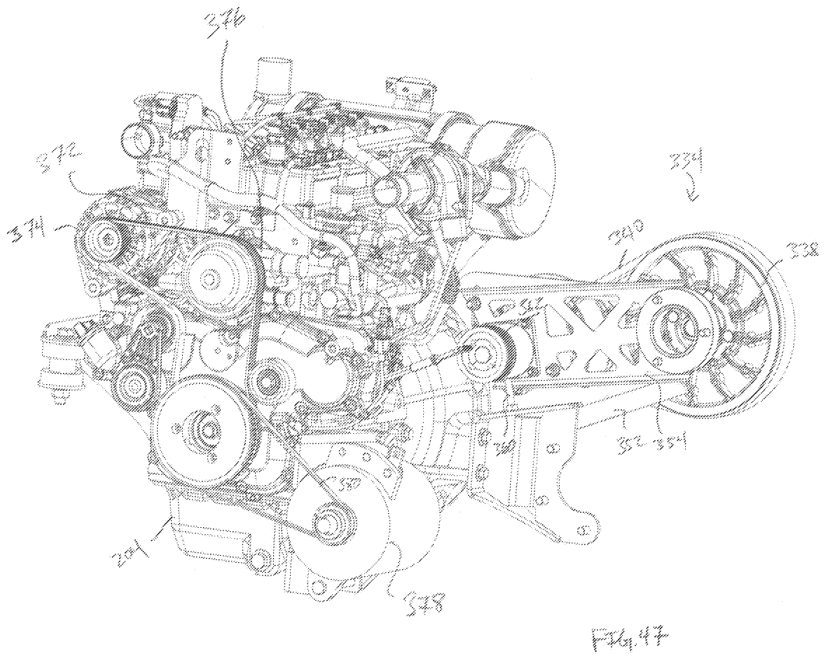

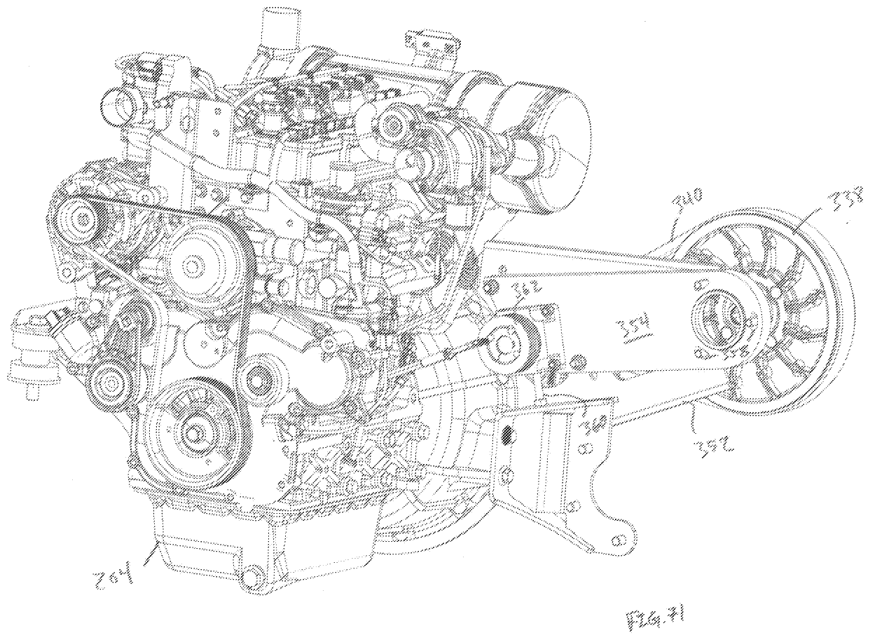

In order to maintain proper tension in the drive belt 344, a drive belt tensioning assembly 350 is utilized. The drive belt tensioning system 350 includes a main support member 352 which, in some embodiments, is fixedly attached to a bellhousing or other portion of the prime mover 204. The drive belt tensioning system 350 further includes a tensioning support member 354. The tensioning support member 354 pivots around the axis of the driven clutch 338/power input shaft 342 (FIG. 33) of the range transmission 208. In this way, the tensioning support member 354 also pivots relative to the main support member 352. Once the desired tension in the drive belt 344 is achieved, cinch fasteners 356 (e.g., bolts) can be tightened to secure the tensioning support member 354 in place. In order to permit pivoting of the tensioning support member 354 relative to main support member 352, the main support member 352 has slots 358 at each of the cinch fasteners 356. As shown in FIGS. 47 and 71, a tension adjuster (e.g., bolt) 360 can be turned to thread the tension adjuster in or out and adjust the position of the tensioning support member 354 relative to the main support member 352.

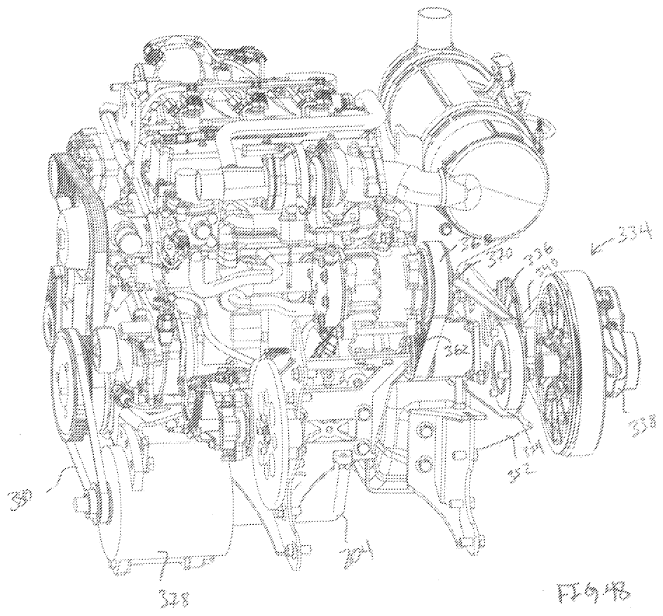

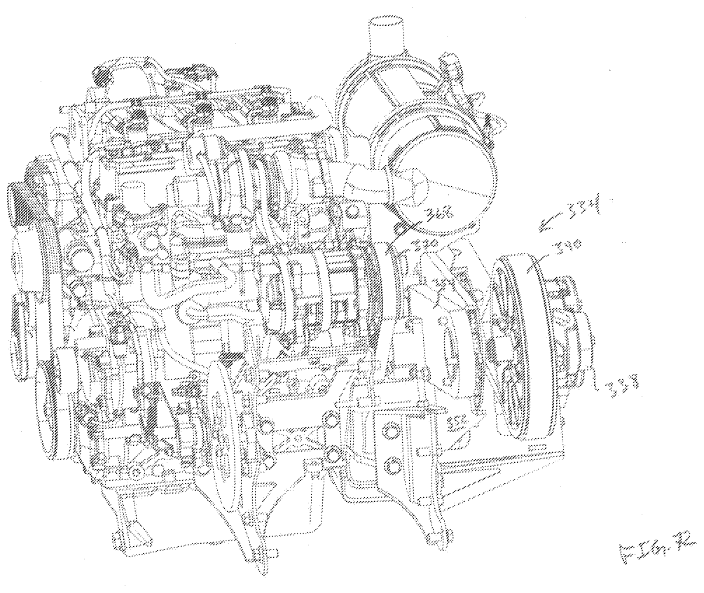

In some embodiments, the clutch pulley 348 rotates first accessory pulley 362 (FIGS. 47, 71) via first common shaft 364 (FIGS. 46, 70). As will be appreciated, the drive clutch 336 is also carried by first common shaft 364. In some embodiments, the tension adjuster 360 acts against a portion of first common shaft housing 366. As shown in FIGS. 48 and 72, in some embodiments, an accessory, such as an air conditioning compressor, is driven by a first accessory belt 368 extending around a second accessory pulley 370 (e.g., A/C compressor pulley) and also around the first accessory pulley 362.

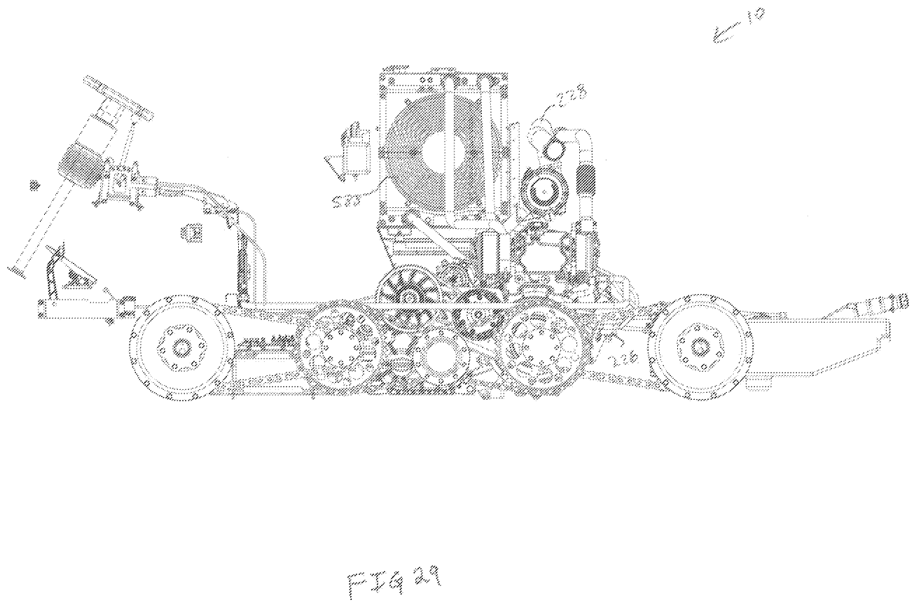

As further shown in FIG. 47, additional accessories may be driven by the prime mover 204, for example via a serpentine belt 372 or in any suitable manner. In some embodiments, the prime mover 204 drives a first alternator 374 (or generator) to produce 12V or 24V power for the main electrical systems of the vehicle 10 (e.g., lights, display, etc.), via the serpentine belt 372. As shown in FIG. 47, the serpentine belt 372 also drives a water pump 376. In some embodiments, the prime mover 204 also drives a second alternator 378 (or generator), for example a 48V alternator. The second alternator 378 provides power to the steer battery 218 (FIG. 27) and steering motor 222. Further, in some embodiments, the second alternator 378 also provides power to electric motor driving cooling fan 214. In some embodiments, the second alternator 378 is driven by a second accessory belt 380. The electric motor driving cooling fan 214 is disposed behind the fan shroud 588 (FIG. 29).

In some embodiments, the electric motor driving cooling fan 214 has a fan controller coupled thereto. In turn, the fan controller has one or more inputs, for example including one or more of the following: engine coolant temperature sensor-measuring the temperature of the engine coolant, steering motor temperature sensor-measuring the temperature of the steering motor, CVT belt temperature sensor-measuring the temperature of the CVT belt, battery temperature sensor-measuring the temperature of the steer battery 218 (or batteries), and one or more controller temperature sensors (e.g., motor controller, fan controller, etc.)—measuring the temperature of the one or more controller temperature(s). In this way, the fan controller will modulate the speed (RPM) of the cooling fan 214. Further, in some embodiments, the direction of rotation of cooling fan 214 can be reversed in order to clear debris that may be stuck to one or more portions of the right air exchange vents 78 or fan shroud. In some embodiments, the direction is reversed by an operator via a switch in the cab portion 16. In some embodiments, however, if the fan controller determines that one of the aforementioned inputs is out of range (e.g., too hot), it will automatically reverse the direction of rotation of the cooling fan 214 in order to clear debris and then resume the standard direction of rotation.

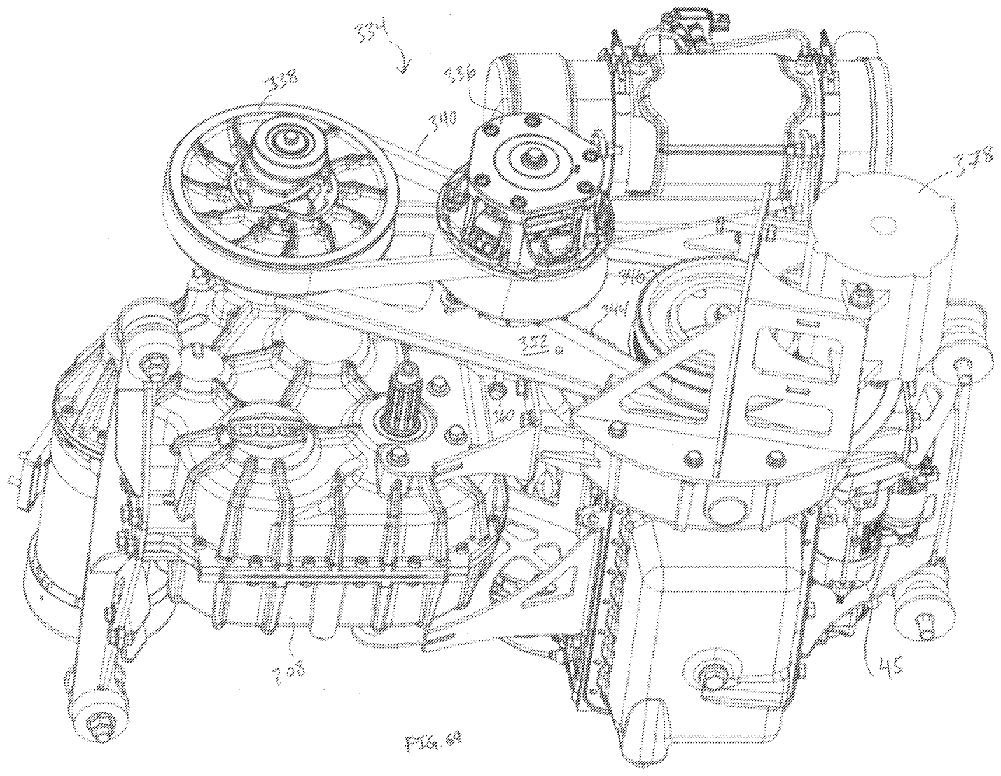

As shown in FIGS. 45 and 47, in some embodiments, the second alternator 278 is positioned on the opposite side of the prime mover 204 as the CVT. As shown in FIGS. 69 and 70, in some embodiments, the second alternator 378 is positioned on the same side of the prime mover 204 as the CVT.

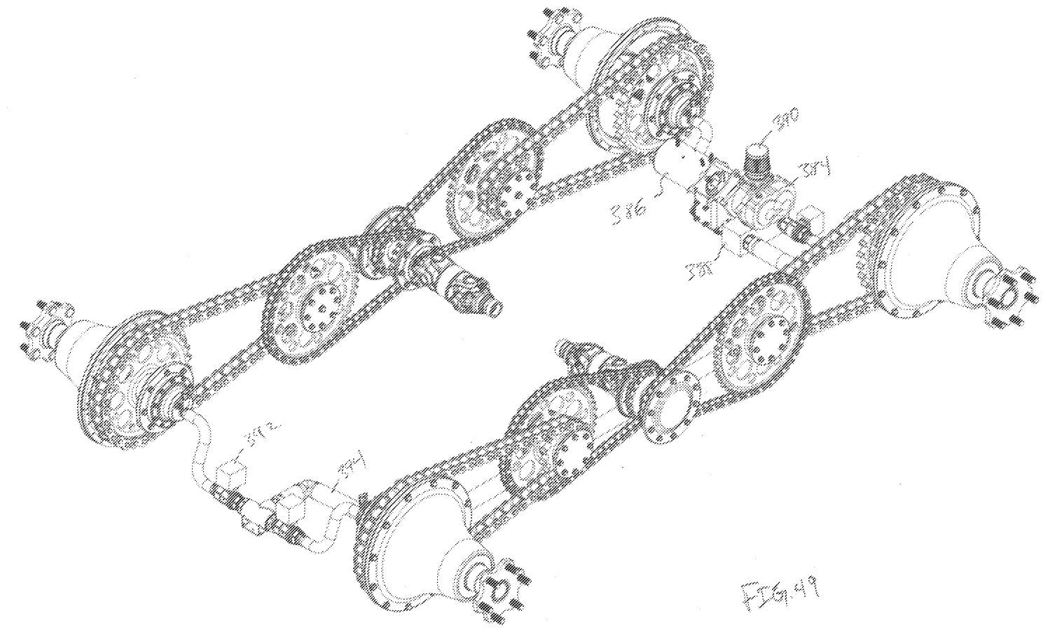

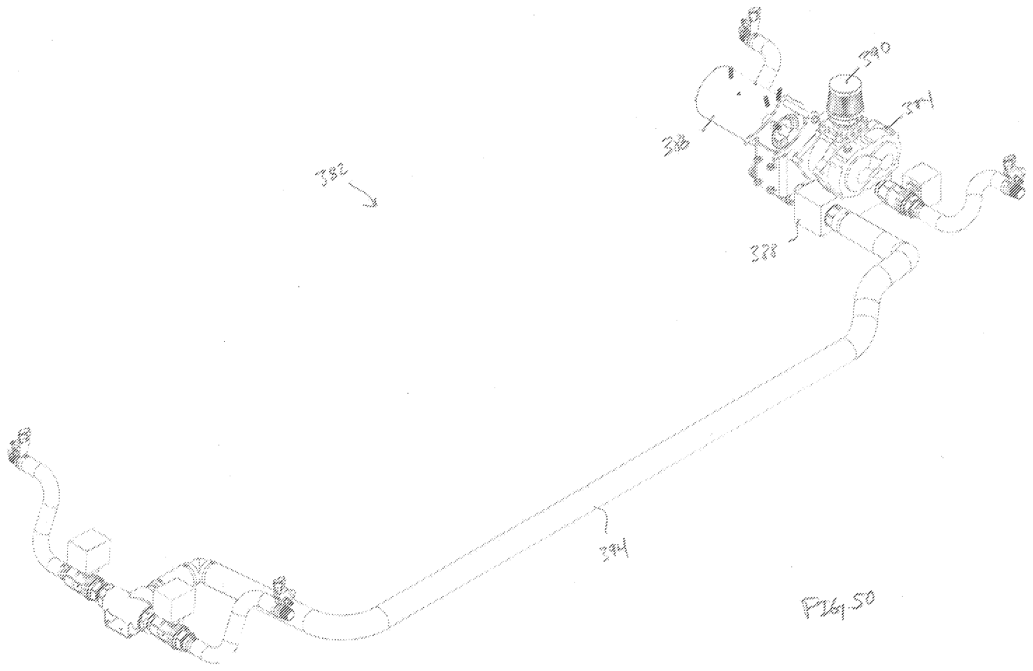

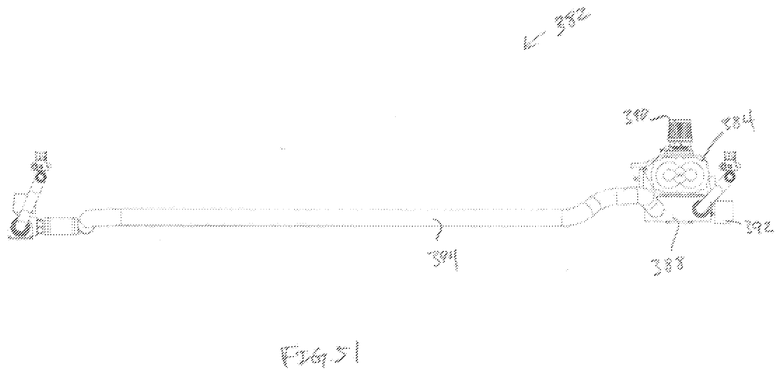

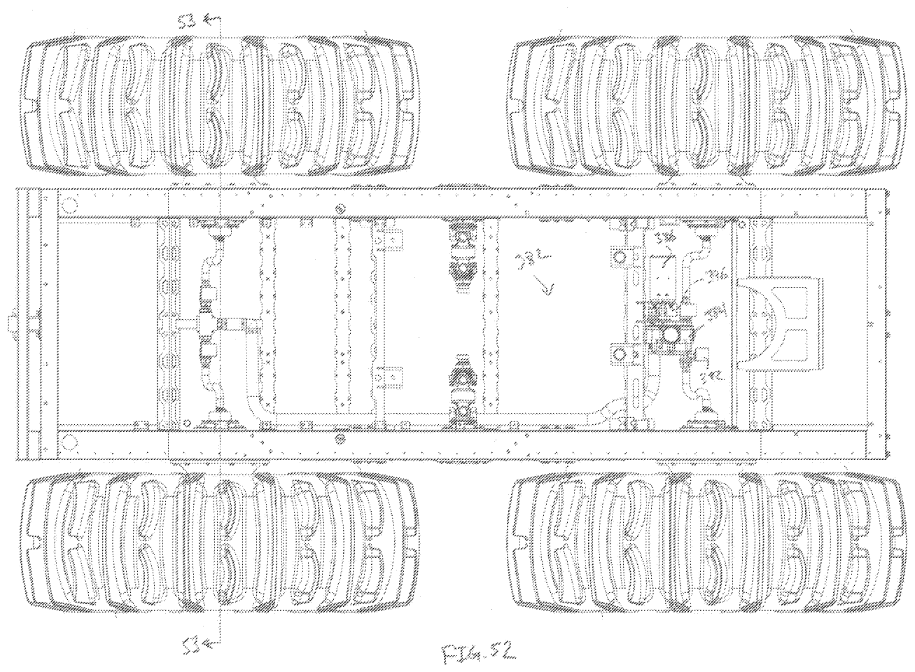

Turning to FIGS. 49-54, an embodiment of the central tire inflation system 382 is now described. The central tire inflation system 382 permits an operator to inflate and deflate one or more of the tire 14 from inside the cab of the vehicle 10. In some embodiments, the central tire inflation system 382 includes an air pump 384, which is powered by electric motor 386, air manifold 388, which is attached to air pump 384, air filter 390, one or more air valves 392, and air supply hose 394. In some embodiments, there is an air valve 392 for administration of air to each of the tires 14 (e.g., right front air valve to provide air to the right front tire, left front air valve to provide air to the left front tire, right rear air valve to provide air to the right rear tire, left rear air valve to provide air to the left rear tire). As shown in FIG. 49, for example, each of the air valve is nearest the respective tire which it serves, however this need not be the case. In some embodiments, the central tire inflation system 382 further includes a dump valve 396 (FIG. 52), which permits an operator to reduce air pressure in one or more of the tires. In some embodiments, the central tire inflation system 382 has five total valves.

In the event an operator desires to increase the air pressure in one or more of the tires 14 (FIG. 1), the operator can make an appropriate selection on a switch, dial, or display in the cab portion. In doing so, one or more of the valves 392 will open and the electric motor 386 will power the air pump 384 to delivery air through the respective valve 392 to the respective tire 14. While inflating the tire(s), the dump valve 396 will remain closed. In some embodiments, all of the valves 392 will operate together, however, in some embodiments, they will cycle so that air is only going into one tire at a time. In yet other embodiments, an operator may choose to have different air pressure in one or more of the tires. For example, if the operator wishes to have more air pressure in the rear tires than the front tires, the operator can elect to have the front valves remain closed while the rear valves are open and the electric motor 386 is powering the air pump 384. Further still, if the operator wishes to have more air pressure in the right tires than the left tires, the operator can elect to have the left valves remain closed while the right valves are open and the electric motor 386 is powering the air pump 384. In still further embodiments, an operator can select amongst various driving modes such as: road (hard surface), snow, trail, water, mud.

In still further embodiments, an operator can select amongst various driving modes such as: road (hard surface), water, trail, mud, snow. In some embodiments, tire pressure is pre-set by the system as follows:
Road: 3.3 PSI (pounds per square inch);
Water: 3.0 PSI
Trail: 2.5 PSI
Mud: 2.0 PSI
Snow: 1.5 PSI
   By selecting the mode, the valve controller will automatically actuate the valves to adjust the air pressure in one or more of the tires, for example having higher air pressure in the hard-surface mode than in the sand mode. Additionally, if an operator is driving along an incline (e.g., perpendicular to the incline) and wishes to have the vehicle be level (or more level, depending on the degree of incline), the operator may select a leveling mode such that the tires on the down-hill side of the vehicle have a higher air pressure than the up-hill side of the vehicle.

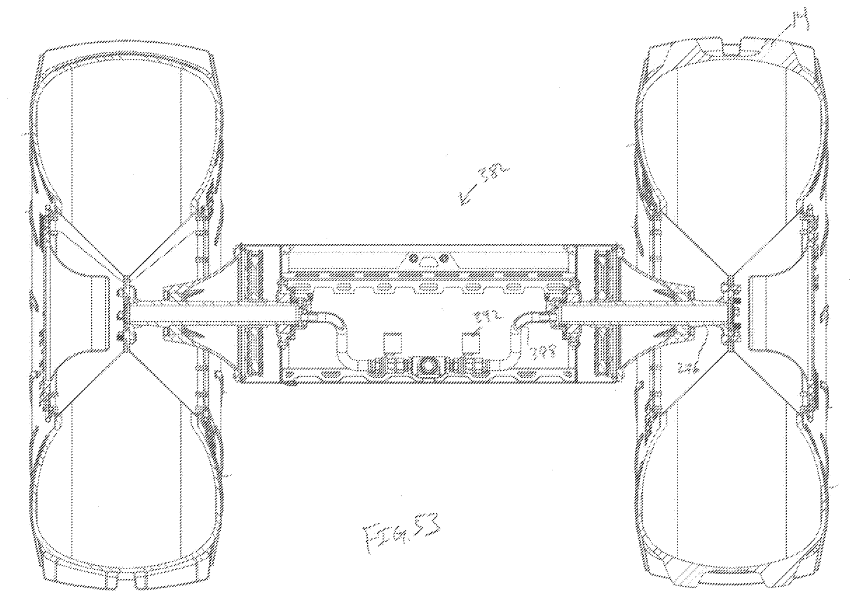

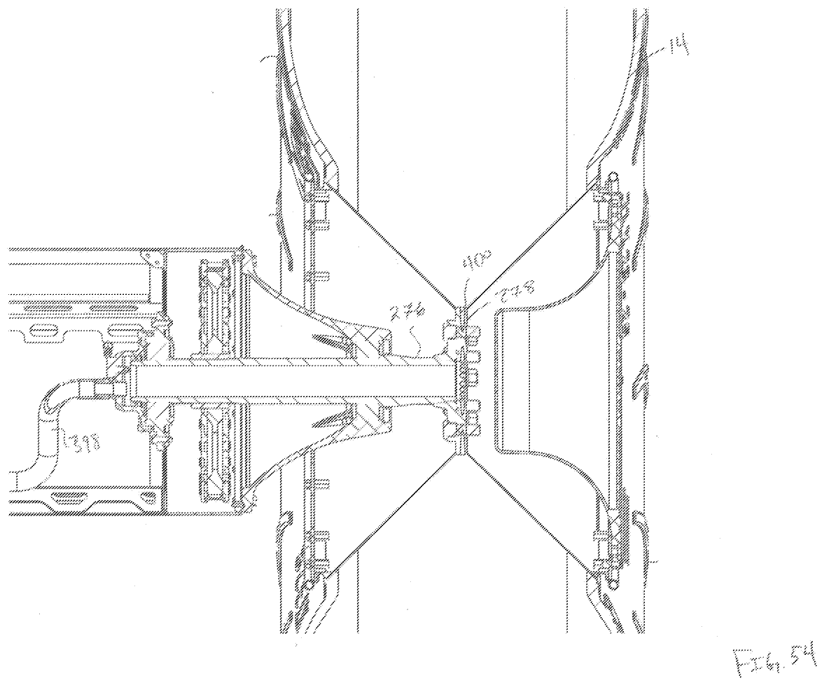

With specific reference to FIGS. 53 and 54, in some embodiments, the air flows into a respective tire by way of post-valve fill line 398. The post-valve fill line 398 provides the compressed air to the hollow portion of the axle shaft (e.g., front axle shaft 276). From there, the compressed air travels outward into the tire 14 through one or more tire inflation orifices 400 which extend radially through a spacer placed between the inner wheel half and the outer wheel half (e.g., front wheel hub 278). In some embodiments, however, the wheel hub simply has a hollow extending axially therethrough and air is plumbed into the tire 14 via a conduit extending through a portion of the wheel.

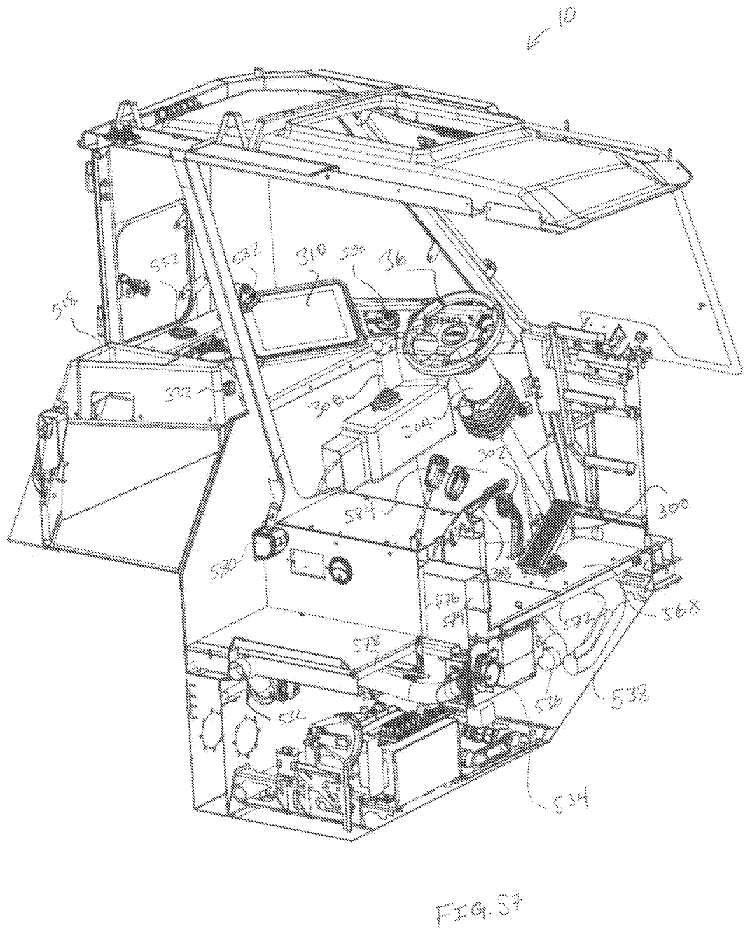

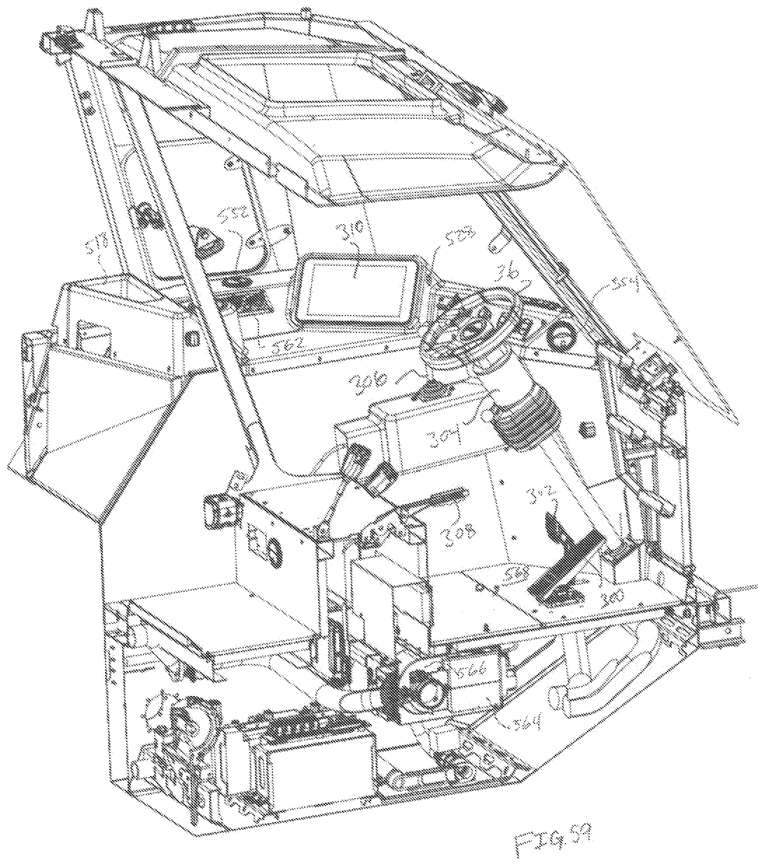

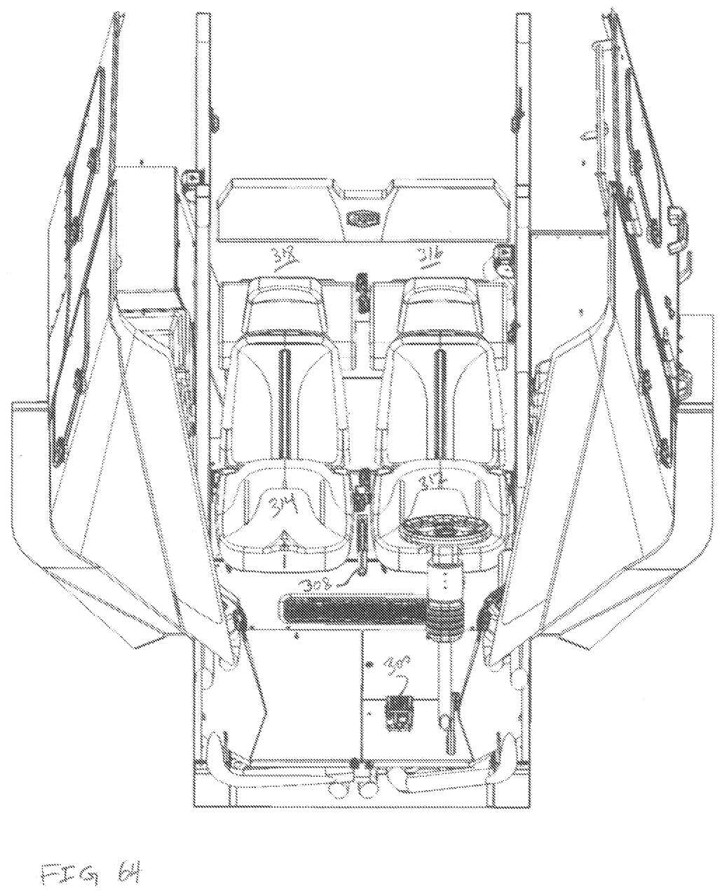

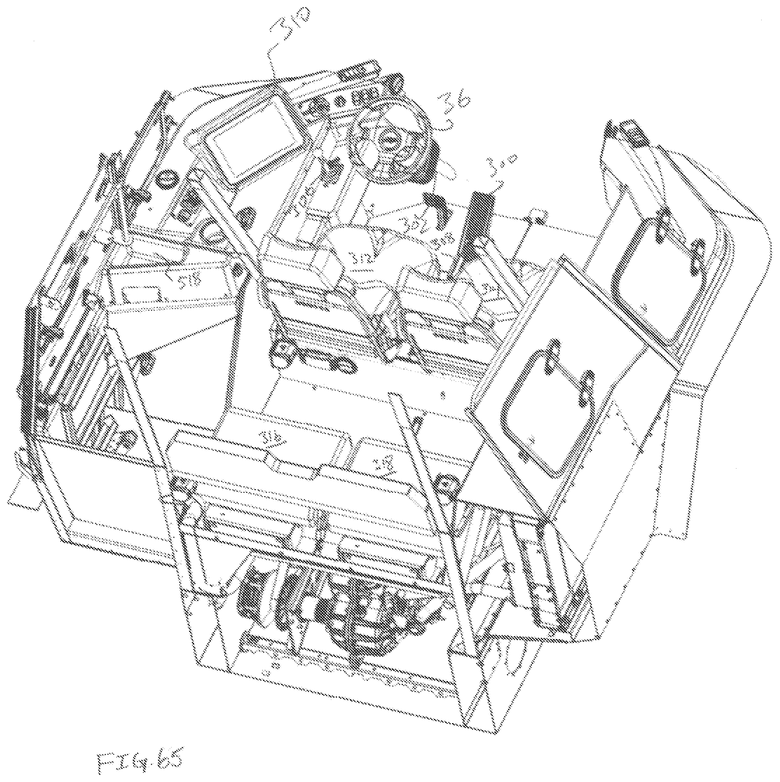

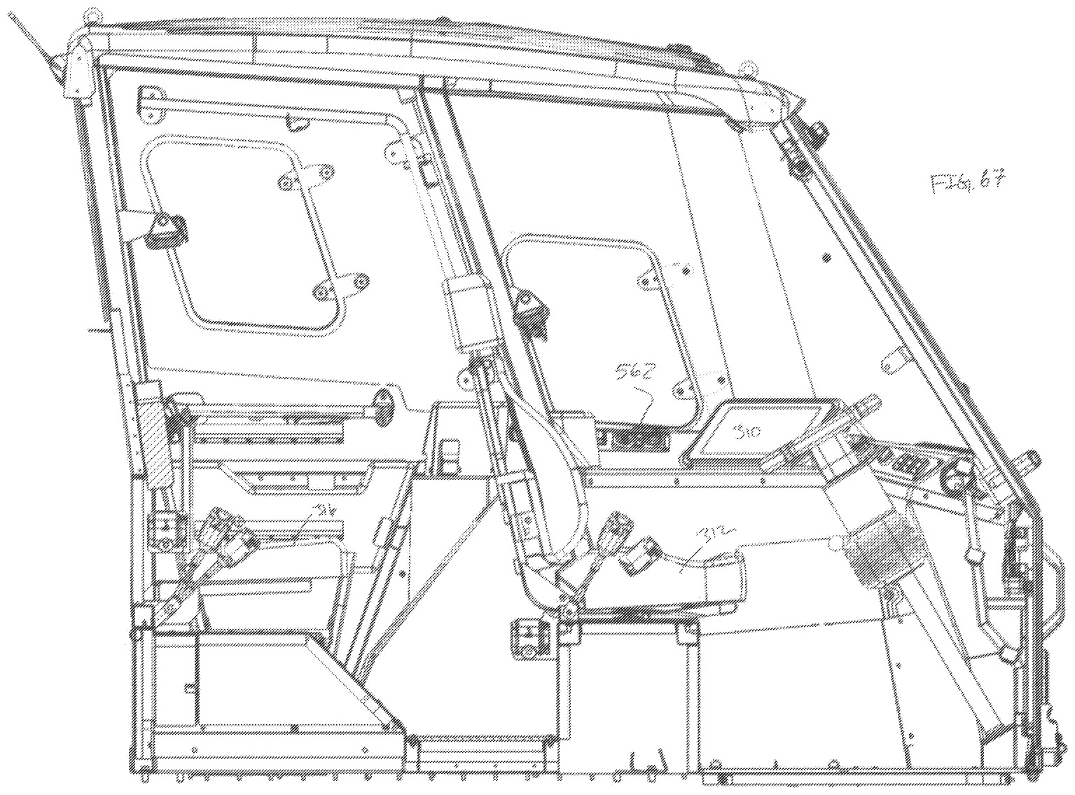

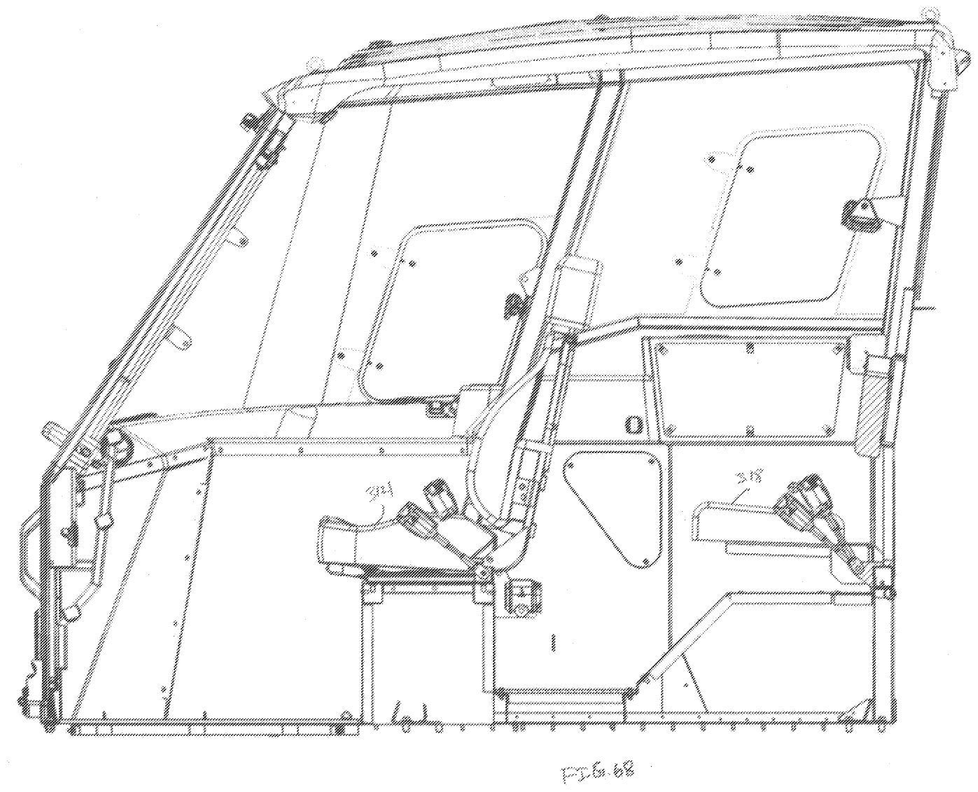

As further illustrated in FIGS. 57-68, the vehicle 10 includes a steering wheel 36, which an operator utilizes to steer the vehicle 10. In some embodiments, the vehicle 10 is a skid steering vehicle so that the ground engaging members 14 (e.g., FIG. 1) on one side rotate at a faster or slower rate than the other side in order to steer the vehicle 10. In some embodiments, the vehicle 10 further includes a throttle pedal 300, brake pedal 302 (discussed previously), steering column 304, range selector 306, hand brake 308 (discussed previously), and display 310. The range selector 306 permits an operator to select gear ranges in the range transmission 208, for example: park, reverse, neutral, hi-range forward, and low-range forward. As will be appreciated, the range selector 306 will correspond to the gear ranges in the range transmission 208 (e.g., where the range transmission 208 has reverse, neutral, hi-range forward, and low-range forward, for example, the range selector 306 will have a corresponding selection option for each of reverse, neutral, hi-range forward, and low-range forward). The hand brake 308 can serve, for example, as a parking brake and/or emergency brake. In some embodiments, the display 310 is a suitable flat-panel with vehicle information such as speed, coolant temperature, oil pressure, tire pressure, engine RPM, fuel level, etc.

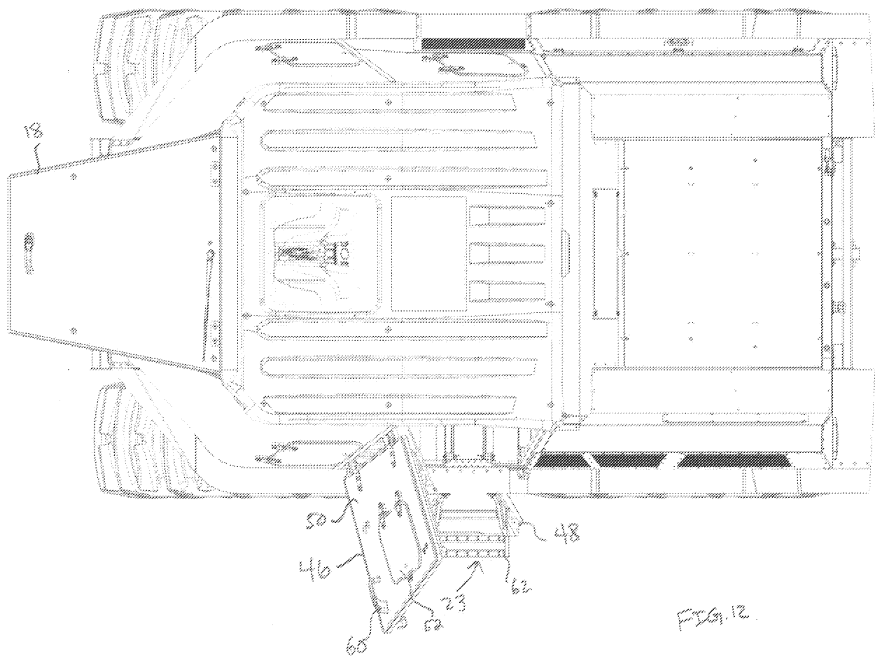

With further regard to FIGS. 62-66, in some embodiments, vehicle 10 includes front seats 312, 314 (left and right, respectively). As shown, the left front seat 312 is where a vehicle operator sits to operate the vehicle 10, however, the vehicle controls can be configured in any suitable way (e.g., left or right side). As further shown, the right front seat 314 is configured as a passenger seat. The left front seat and the right front seat each have a seating surface and seat back. In some embodiments, the vehicle 10 further includes rear seating area, for example including left rear seat 316 and right rear seat 318. Further, the left rear seat 316 and the right rear seat 318 each have a seating surface and a seat back. In some embodiments, the seating surface of the rear seats are higher than the seating surface of one or both of the seating surfaces of the front seats, thereby providing forward visibility for the rear passengers. In some embodiments, the left front seat 312, right front seat 314, left rear seat 316, and right rear seat 318 have seat belts, for example three-point seat belts. In some embodiments, passengers access left rear seat 316 and right rear seat 318 via side entry access 23 (FIG. 12), while the left front seat 312 and right front seat 314 are accessed via front entry access 21 (FIG. 10).

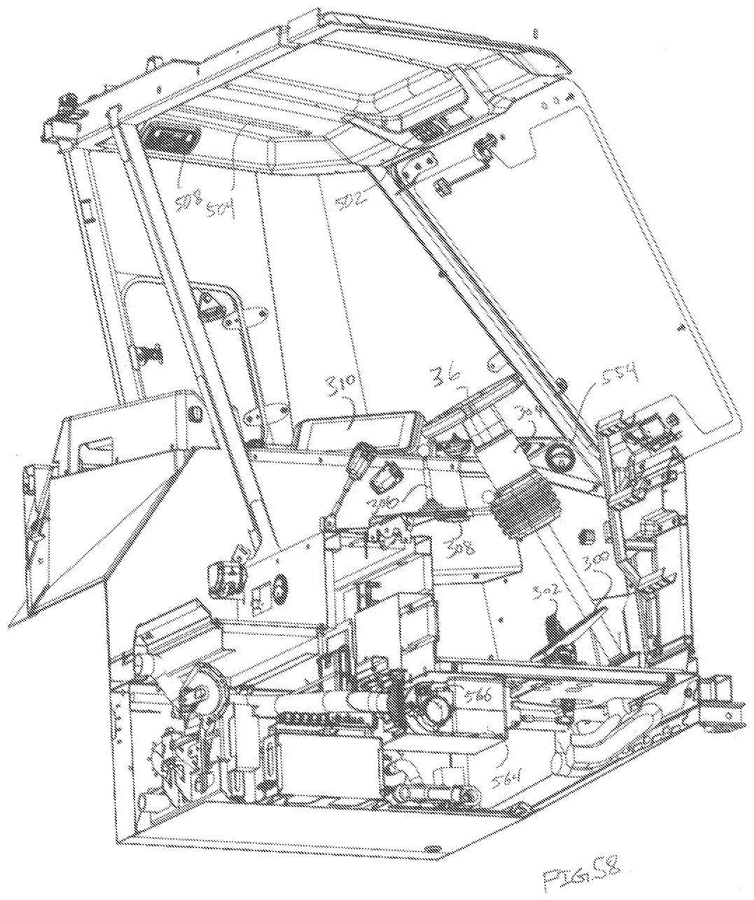

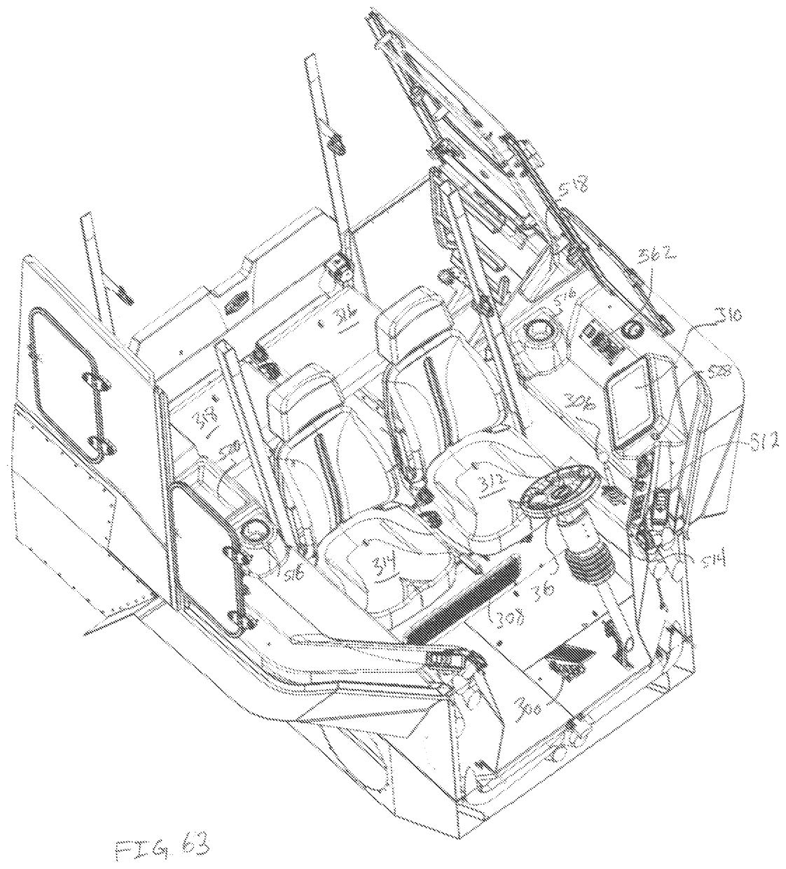

In some embodiments, for example as shown in FIG. 57, the vehicle 10 includes a multifunction switch 500 for controlling the front lights 124 (FIG. 4), turn signal lights, and horn 506. An accessory switch (or panel of accessory switches) 502 (FIG. 58) are utilized, in some embodiments, to control interior lights 504, box illumination light 130 (FIG. 5), and other exterior lighting. Referring to FIGS. 58 and 60, in some embodiments, the vehicle 10 includes a radio 508 which is connected to one or more speakers 510. Referring to FIG. 63, in some embodiments, the vehicle 10 also includes bilge control 512. Bilge control 512 can be used to run the bilge pump(s) to evacuate water from the bottom of the chassis 12, turn the bilge pump(s) on standby to run automatically if water at the bilge pump rises to a certain level, or turn off the bilge pump(s). Additionally, hazard control 514 is used to turn on/off the hazard lights.

In some embodiments, for example as shown in FIG. 63, the vehicle 10 includes one or more integrated beverage holders 516, one or more integrated storage compartment 518, 520, one or more USB charging ports (e.g., rear USB charging port(s) 522 (FIG. 57) and front USB charging port(s) 524), 12V charge adaptor port 526, and an inclinometer 528 (FIG. 62). Information obtained from the inclinometer may be displayed to the operator, for example, on the display 310. Additionally, in some embodiments, the vehicle 10 includes an alarm associated with the inclinometer to warn the operator if the vehicle 10 is nearing its inclination limit.

With further reference to FIGS. 57-63, in some embodiments, the vehicle 10 includes an HVAC (heating, ventilation, and air conditioning) system to provide a climate controlled environment inside the cab portion 16 of the vehicle 10. The HVAC system includes one or more duct members 532 through which heated air and cooled air can travel. The duct members 532 include a fresh air intake duct member 534, first forward lower circulating duct member 536, second forward lower circulating duct member 538, first upper circulating duct member 540, second upper circulating duct member 542, third upper circulating duct member 544, and fourth upper circulating duct member 546. As will be appreciated, one or more of the duct members are routed to cabin vents such as rear passenger cabin vents 548, 550, left-rear upper side vent 552, left-front upper side vent 554, right-front upper side vent 556, and right-rear upper side vent 558. In some embodiments, HVAC system further includes a heater core, coolant loop 560 to the heater core (not shown), and proportional valve (not shown) to control the rate of circulation of coolant through the coolant loop 560, and HVAC control 562. An operator can utilize the HVAC control 562 to adjust various aspects of the HVAC system such as circulating fan speed, temperature, air conditioning. In some embodiments, the HVAC system includes an integrated evaporator 564, heating core (not shown), and circulating fan 566. As shown, the evaporator 564 is disposed below the floor 568 of the cab portion and in a cavity of the chassis 12.

In some embodiments, in order to reduce noise and increase comfort in the cab portion, on or more sound and vibration deadening sheets, panels, and/or materials are utilized. In some embodiments, sound abatement members are included beneath and/or adjacent to one or more portions of the floor 568 of cab portion 16. As shown in FIG. 57, for example, sound abatement members include operator floor sound abatement member 572, passenger floor sound abatement member 578, operator wall sound abatement member 574, and passenger wall sound abatement member 576. In some embodiments, the sound abatement members are formed from vertically lapped polyester material.

In some embodiments, the vehicle 10 includes a three-point seat belt system for each occupant. As shown in FIG. 57, the three-point seat belt system includes lap belt and shoulder belt, with belt recoil 580, shoulder belt support 582, and belt latch 584.

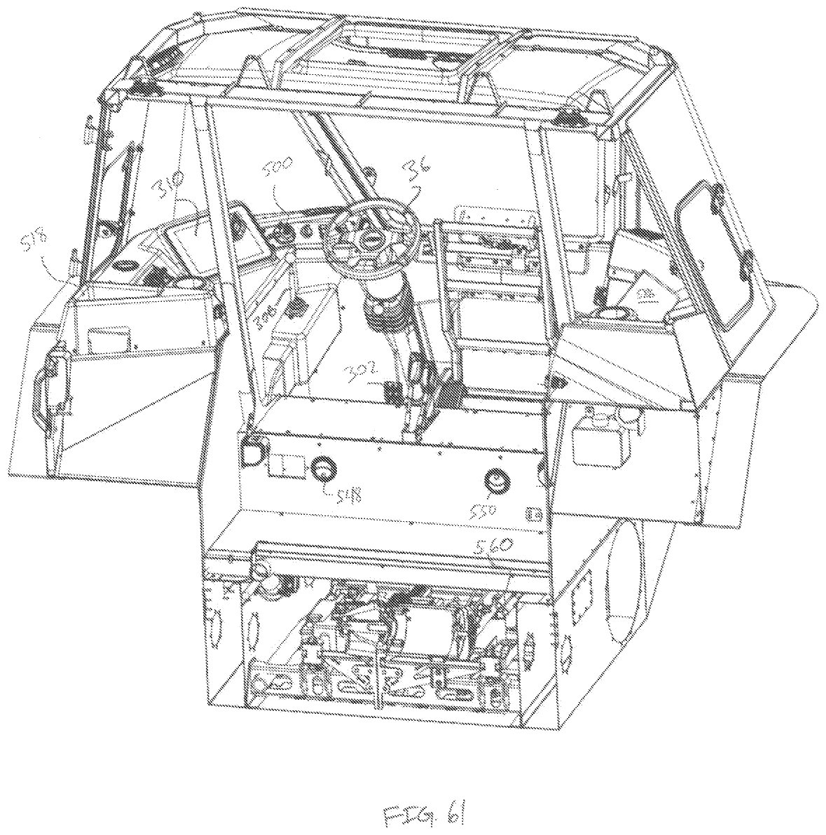

With further reference to FIGS. 62 and 63, in some embodiments, the seat base of the left rear seat 316 and right rear seat 318 tip upwardly and are stowable, for example where the rear seating area is to be used for more storage space (as opposed to occupants). Further, in some embodiments, the vehicle 10 has one or more contoured console portions 586 (FIG. 61) formed via vacuum forming. These contoured console portions 586 yield a soft surface with good aesthetics, fit, and finish.

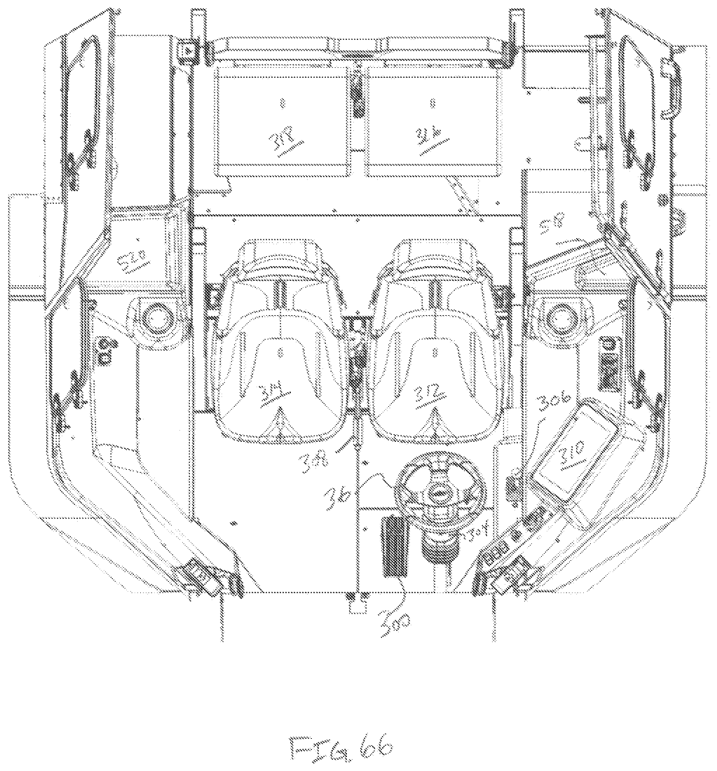

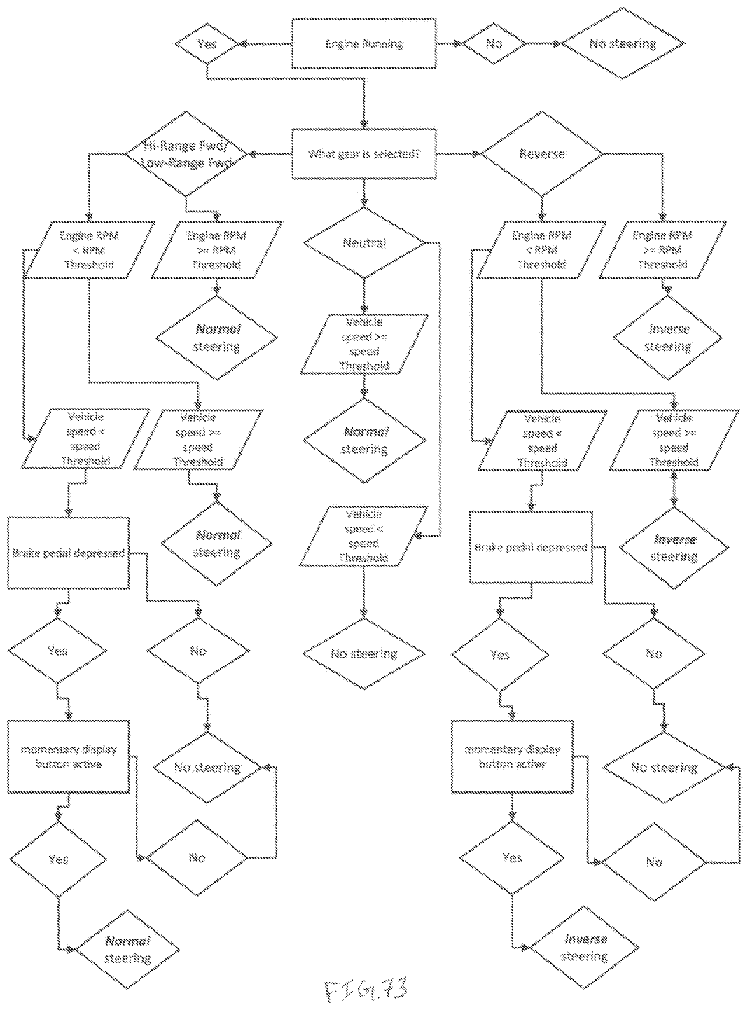

In some embodiments, and as previously discussed, the vehicle 10 utilizes a steering motor 222 (FIG. 27) to provide steering input into the range transmission 208 (FIG. 27). A steering controller takes signals from the steering wheel 36 (FIG. 66) and provides commands to the steering motor 222 in the form of electrical power from steer battery (or steer batteries) 218 (FIG. 27). Discussed now with respect to FIG. 73, various steering characteristics are described. In some embodiments, the vehicle 10 is “steer-by-wire” and the steering characteristics can be altered depending on conditions. For example, in some embodiments, if the prime mover (e.g., engine) isn't running then the steering is disabled. In some embodiments, however, the steering may still operate even if the prime mover is not currently running—in this way, the vehicle 10 is still able to conduct a zero-turn. In some embodiments, when the range transmission is in neutral, if the vehicle speed is greater than, or equal to, a threshold speed (e.g., more than two miles-per-hour (MPH), three MPH, four MPH, five MPH, etc.) then steering is enabled, whereas if the vehicle speed is below the threshold speed, steering is not enabled. Further, in some embodiments, when the range transmission is in a forward range, the steering will exhibit normal characteristics when certain conditions have been met, such as the prime mover (e.g., engine) speed is greater than, or equal to, a threshold RPM (e.g., 1000 RPM, 1200 RPM, 1500 RPM). Additionally, in some embodiments, in addition to meeting the RPM threshold, the vehicle speed must be greater than, or equal to, a threshold speed (e.g., more than two miles-per-hour (MPH), three MPH, four MPH, five MPH, etc.), as well as having the brake pedal depressed and the momentary display button being active for the vehicle 10 have normal steering. When the range transmission is in reverse, in some embodiments, the vehicle 10 will have certain requirements for the steering to be enabled, however, the steering will be inverted from the normal steering.

The above disclosure is intended to be illustrative and not exhaustive. This description will suggest many variations and alternatives to one of ordinary skill in this field of art. All these alternatives and variations are intended to be included within the scope of the claims where the term “comprising” means “including, but not limited to.” Those familiar with the art may recognize other equivalents to the specific embodiments described herein which equivalents are also intended to be encompassed by the claims.

What is claimed is:

1. An amphibious vehicle comprising:
a chassis;
a front entry access;
a side entry access having a side lower door, the side lower door having a closed configuration and an open configuration;
a splash shield extending around at least a portion of the vehicle, wherein a portion of the splash shield is attached to the side lower door and has a first surface and a second surface, and wherein, when the side lower door is in the closed configuration the first surface faces upwardly and when the side lower door is in the open configuration the first surface faces downwardly.

2. The amphibious vehicle of claim 1, further comprising a continuously variable transmission.

3. The amphibious vehicle of claim 1, further comprising a range transmission, the range transmission having at least one forward speed and one reverse speed.

4. The amphibious vehicle of claim 3, wherein the range transmission has at least one set of epicyclic gears.

5. The amphibious vehicle of claim 3, further comprising a steering wheel.

6. The amphibious vehicle of claim 5, further comprising a steering motor, the steering motor coupled to the range transmission, wherein rotation of the steering wheel provides a signal to command the steering motor.

7. The amphibious vehicle of claim 1, further comprising front seats and rear seats, wherein at least one the front seats and at least one of the rear seats are forward facing.

8. An amphibious vehicle comprising:
a chassis;
a front entry access;
a prime mover having a crankshaft axis;
a range transmission; and
a CVT, the CVT having a drive clutch and a driven clutch, wherein the drive clutch has an axis about which it rotates and wherein the axis of the drive clutch is offset from the crankshaft axis.

9. The amphibious vehicle of claim 8, wherein the crankshaft axis extends transversely relative to the amphibious vehicle.

10. The amphibious vehicle of claim 9, further comprising an electric steering motor.

11. The amphibious vehicle of claim 10, wherein the electric steering motor is coupled to the range transmission.

12. The amphibious vehicle of claim 11, further comprising a box portion, the box portion having a tailgate, the tailgate opening about one or more tailgate hinges.

13. An amphibious vehicle comprising:
a chassis;
a cab portion affixed to the chassis, the cab portion having a front entry access and a side entry access;
at least four tires, the at least four tires each having a diameter of at least 60 inches;
a prime mover comprising a diesel engine, wherein the diesel engine has a crank pulley coupled thereto;
a CVT comprising a drive clutch and a driven clutch, the drive clutch being coaxial with a clutch pulley, wherein the crank pulley and the clutch pulley are rotationally coupled to one another via a drive belt, and wherein the drive clutch and the driven clutch are coupled via a CVT belt;
a range transmission having a power input shaft and a steering input, wherein the driven clutch rotationally coupled to the power input shaft;
a steering motor, the steering motor rotationally coupled to the steering input;
a steering wheel; and
a tire inflation system, the tire inflation system comprising an air pump, an electric motor, and a plurality of air valves, wherein the tire inflation system is coupled to the at least four tires.

14. The amphibious vehicle of claim 13, further comprising a first alternator and a second alternator.

15. The amphibious vehicle of claim 13, further comprising a box portion, wherein the box portion includes a storage locker.

16. The amphibious vehicle of claim 13, further comprising a radiator and a radiator cooling fan, the radiator cooling fan being rotationally coupled to an electric motor.

17. The amphibious vehicle of claim 13, further comprising a box portion and a box illumination light, the box illumination light selectively providing illumination for the box portion.

18. The amphibious vehicle of claim 13, further comprising a brake system, the brake system comprising a brake pedal, a hand brake, and a brake disc, wherein both the brake pedal and the hand brake are configured to act on the brake disc.

19. The amphibious vehicle of claim 13, further comprising a drive belt tensioning assembly, the drive belt tensioning assembly comprising a CVT tensioning support member and a main support member, wherein the CVT tensioning support member is pivotable relative to the main support member.

20. The amphibious vehicle of claim 13, wherein the crank pulley has a larger diameter than the clutch pulley.
